(19) United States
(12) Patent Application Publication
(10) Pub. No.: US 2026/0364718 A1
(43) Pub. Date: Nov. 19, 2026

(54) LASER-BASED BOARD-SHAPED MATERIAL PROCESSING DEVICE, SYSTEM, AND METHOD

(71) Applicant: HAWK MACHINERY CHINA CO., LTD., Changzhou (CN)

(72) Inventors: Kai WANG, Changzhou (CN); Liang FENG, Changzhou (CN); Yongtian ZHANG, Changzhou (CN)

(21) Appl. No.: 19/209,917

(22) Filed: May 16, 2025

(51) Int. Cl. B23K 26/38; B23K 26/402

(52) U.S. Cl. CPC B23K 26/38; B23K 26/402

(57) ABSTRACT

A laser-based board-shaped material processing method includes: operating a laser platform such that a laser spot emitted by a laser covers a portion of a part of the substrate layer corresponding to the second corner and a totality of a part of the decorative layer corresponding to the second corner; and using the laser to perform heat treatment so as to heat a part of the wear-resistant layer corresponding to the second corner to a moldable state, such that extrusion molding processing is applicable to the second corner to form a rounded corner.

### FIELD OF THE INVENTION

The present disclosure relates to the field of board-shaped material processing. More specifically, the present disclosure relates to techniques for a laser-based board-shaped material processing device, a laser-based board-shaped material processing system, and a laser-based board-shaped material processing method.

### BACKGROUND OF THE INVENTION

In implementations such as household items and decoration materials, lock flooring, or a floor panel with at least one mechanical locking, is widely used. Floor panels are paved by means of mechanical locking parts that form a mutual locking of the floor panels. The mechanical locking parts are engaged with one another, and therefore are prone to frictional strain during prolonged engagement, especially at the corners of the lock engagement. Corners with a right-angled shape may not provide sufficient contacting area and locking force, resulting in insufficient tightness at floor joints, which may lead to increased gaps over time. In addition, when the corners with a right-angle shape are subjected to external forces, such as an individual's stepping on or moving furniture, they are more likely to produce stress concentration, which will lead to wear or damage to the corners, thereby affecting the lifetime of the floor as well as the flatness and installation effect of the floor. Therefore, there is a need to process corners into rounded corners, i.e., corners having a rounded shape. Conventionally, there are several processing schemes for processing notches into rounded corners. One conventional processing scheme is to directly use a milling cutter to cut the corners of the locks on small plates, but this will destroy the surface of the floor plates and increase the operation costs. For example, U.S. Pat. No. 10,988,939B2 discloses a floor panel with a substrate and coupling parts realized from the substrate, which allow a mechanical locking between two floor panels, and also discloses that the coupling parts are performed by means of cutting tools, such as milling tools. Another conventional processing scheme is to apply heat pressing treatment along the corner line on big plates before cutting big plates into small plates, and form rounded corners on the big plates by heat pressing. After the heat pressing, one can saw large plates into small plates along the corner line, and then apply lock processing to small plates. However, this needs to accurately position the plates, and the sawing step is likely to destroy the roundness of the corners, and processing deviation is likely to happen, thereby affecting the lock quality and splicing stability of the floor.

Laser is used for cutting during the processing or machining according to some references. For example, U.S. Pat. No. 8,056,236B2 discloses a method for manufacturing floor panels, at least partially by means of a laser treatment of a board-shaped material. The laser treatment is applied for removing a material portion from the top layer and for forming a cut, and the laser treatment defines a profiled edge area. U.S. Pat. No. 10,421,683B2 discloses a method for the laser-based machining of a sheet-like substrate. The method includes directing a laser beam into a material to generate an induced absorption within the material. The induced absorption causes local heating of the material along the focal line of the laser beam, and the local heating results in crack formation so as to separate the material into pieces. However, using laser to cut or separate materials causes removal of multiple layers, such as wear-resistant layer or decorative layer on top of the substrate, and this will destroy the surface of the floor plates and increase the operation costs.

U.S. Patent Application Publication US 2008/0202167A1 discloses a thermal edge finishing process. The edge finishing process includes pre-heating a cut edge of a glass sheet with sharp corners, then heating the pre-heated edge with a laser, and then annealing the edge. Laser polishing may be used to form a clean rounded corner and it saves a separate corner cut to round the corner of the glass sheet. However, the disclosed thermal edge finishing process is applied to a cut edge of a glass sheet, employes a localized heating step and a localized edge annealing step to contain localized stress at the edge, and controls the cool down rate in the annealing step based on glass characteristics such as glass transition temps, strain point, and anneal point. Therefore, the disclosed thermal edge finishing process is not applicable to corner processing of a laminated plate with multiple layers that may have different strain points and anneal points respectively, making it difficult to reconcile the heating step and the annealing step.

U.S. Pat. No. 10,500,684B2 discloses a method for producing mechanical locking systems in a floor panel. The method includes using laser to heat surface layer to soften the wear resistant top layer, so as to ensure accurate wear reduction to keep the lifetime of a fine cutter longer, and then using the fine cutter for profiling to form the mechanical locking systems. However, the disclosed method or producing mechanical locking systems in a floor panel takes the laser heating treatment as part of an incorporated intermediate preprocessing step before the profiling step, and the laser heat treatment serves to only soften the top layer so that the top layer needs not to be removed.

Accordingly, references mentioned above disclose using lasers for cutting a piece from a material or separating the material into pieces, and also disclose using lasers as a preprocessing step before an annealing step or a profiling step. The references have disadvantages of increased operation costs, decreased lock qualities, and less splicing stability. Also, conventional processing schemes and references do not disclose how to adapt to fast changing consumer needs with respect to various sizes and angles of rounded corners in an efficient and cost-saving way.

In light of above, the present disclosure provides a laser-based board-shaped material processing device, a laser-based board-shaped material processing system, and a laser-based board-shaped material processing method, which have advantages of reduced operation costs, increased lock qualities, and increased splicing stability, and are adaptive to fast changing consumer needs with respect to various sizes and angles of rounded corners in an efficient and cost-saving way.

No admission is made that any reference cited herein constitutes prior art or may be interpreted to be harmful to the patentability of the present invention. Applicant expressly reserves the right to challenge the accuracy and pertinency of any cited documents.

### SUMMARY OF THE INVENTION

In accordance with a first aspect of the present disclosure, a laser-based board-shaped material processing device is provided. The board-shaped material processing device includes a laser and a laser platform. The laser is fixed on the laser platform. A board-shaped material that includes a substrate layer, a decorative layer, and a wear-resistant layer is movable along a first direction on a first plane. Along a second direction perpendicular to the first plane are the substrate layer, the decorative layer, and the wear-resistant layer of the board-shaped material in turn. The laser platform is operable to move the laser back and forth in the second direction and to rotate the laser on a second plane that is perpendicular to both the first plane and the first direction. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. The board-shaped material processing device is configured for, operating the laser platform such that a laser spot emitted by the laser covers a portion of a part of the substrate layer corresponding to the second corner and a totality of a part of the decorative layer corresponding to the second corner, and then, using the laser to perform heat treatment so as to heat a part of the wear-resistant layer corresponding to the second corner to a moldable state, such that extrusion molding processing is applicable to the second corner to form a rounded corner.

With reference to the first aspect of the present disclosure, the laser-based board-shaped material processing device has advantages of reduced operation costs, increased lock qualities, and increased splicing stability, and is adaptive to fast changing consumer needs with respect to various sizes and angles of rounded corners in an efficient and cost-saving way.

In accordance with the first aspect of the present disclosure, in a manner of implementation, the decorative layer and the laser are positioned at two opposite sides of the wear-resistant layer in the second direction respectively.

In accordance with the first aspect of the present disclosure, in a manner of implementation, a relative distance between the laser and the decorative layer in the second direction is larger than a relative distance between the laser and the wear-resistant layer in the second direction.

In accordance with the first aspect of the present disclosure, in a manner of implementation, a relative distance between the laser and the decorative layer in the second distance is essentially zero, or, the decorative layer and the laser are both positioned at a same side of the wear-resistant layer in the second direction.

In accordance with the first aspect of the present disclosure, in a manner of implementation, the board-shaped material processing device is further configured for, operating the laser platform such that the laser spot emitted by the laser covers is spaced away from a part of the substrate layer corresponding to the first corner.

In accordance with the first aspect of the present disclosure, in a manner of implementation, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer.

In accordance with the first aspect of the present disclosure, in a manner of implementation, the board-shaped material processing device is further configured for, operating the laser platform so as to locate the part of the decorative layer corresponding to the second corner at a geometric center of the laser spot emitted by the laser.

In accordance with the first aspect of the present disclosure, in a manner of implementation, a working wavelength of the laser is within a preset wavelength range, and, a laser absorption rate in the preset wavelength range of the wear-resistant layer is lower than a laser absorption rate in the preset wavelength range of the decorative layer.

In accordance with the first aspect of the present disclosure, in a manner of implementation, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot.

In accordance with the first aspect of the present disclosure, in a manner of implementation, the laser includes an emission source, a reflective mirror having a parabolic shape, and a convex lens, a laser beam emitted by the emission source first goes through a first focus by the reflective mirror and then goes through a second focus by the convex lens onto a working plane so as to obtain the rectangular laser spot, a length of the long side of the rectangular laser spot is determined base on a length of the emission source and a length of the reflective mirror, a length of a short side of the rectangular laser spot is determined base on a distance from the convex lens to the working plane.

In accordance with the first aspect of the present disclosure, in a manner of implementation, the emission source is deployed on a symmetrical centerline of the parabolic shape of the reflective mirror.

In accordance with a second aspect of the present disclosure, a laser-based board-shaped material processing system is provided. The board-shaped material processing system includes a transporting unit and a laser heating unit. The transporting unit is configured for transporting a board-shaped material along a first direction on a first plane. The board-shaped material includes a substrate layer, a decorative layer, and a wear-resistant layer, and, along a second direction perpendicular to the first plane are the substrate layer, the decorative layer, and the wear-resistant layer of the board-shaped material in turn. The laser heating unit includes a laser and a laser platform. The laser is fixed on the laser platform. The laser platform is operable to move the laser back and forth in the second direction and to rotate the laser on a second plane that is perpendicular to both the first plane and the first direction. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. The laser heating unit is configured for, operating the laser platform such that a laser spot emitted by the laser covers a portion of a part of the substrate layer corresponding to the second corner and a totality of a part of the decorative layer corresponding to the second corner, and then, using the laser to perform heat treatment so as to heat a part of the wear-resistant layer corresponding to the second corner to a moldable state, such that extrusion molding processing is applicable to the second corner to form a rounded corner.

With reference to the second aspect of the present disclosure, the laser-based board-shaped material processing system has advantages of reduced operation costs, increased lock qualities, and increased splicing stability, and is adaptive to fast changing consumer needs with respect to various sizes and angles of rounded corners in an efficient and cost-saving way.

In accordance with the second aspect of the present disclosure, in a manner of implementation, the decorative layer and the laser are positioned at two opposite sides of the wear-resistant layer in the second direction respectively.

In accordance with the second aspect of the present disclosure, in a manner of implementation, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer.

In accordance with the second aspect of the present disclosure, in a manner of implementation, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot.

In accordance with a third aspect of the present disclosure, a laser-based board-shaped material processing method is provided. A board-shaped material that includes a substrate layer, a decorative layer, and a wear-resistant layer is movable along a first direction on a first plane. Along a second direction perpendicular to the first plane are the substrate layer, the decorative layer, and the wear-resistant layer of the board-shaped material in turn. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. The board-shaped material processing method includes: operating a laser platform such that a laser spot emitted by a laser covers a portion of a part of the substrate layer corresponding to the second corner and a totality of a part of the decorative layer corresponding to the second corner; and using the laser to perform heat treatment so as to heat a part of the wear-resistant layer corresponding to the second corner to a moldable state, such that extrusion molding processing is applicable to the second corner to form a rounded corner. The laser is fixed on the laser platform. The laser platform is operable to move the laser back and forth in the second direction and to rotate the laser on a second plane that is perpendicular to both the first plane and the first direction.

With reference to the third aspect of the present disclosure, the laser-based board-shaped material processing method has advantages of reduced operation costs, increased lock qualities, and increased splicing stability, and is adaptive to fast changing consumer needs with respect to various sizes and angles of rounded corners in an efficient and cost-saving way.

In accordance with the third aspect of the present disclosure, in a manner of implementation, the decorative layer and the laser are positioned at two opposite sides of the wear-resistant layer in the second direction respectively.

In accordance with the third aspect of the present disclosure, in a manner of implementation, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer.

In accordance with the third aspect of the present disclosure, in a manner of implementation, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot.

In accordance with the third aspect of the present disclosure, in a manner of implementation, a working wavelength of the laser is within a preset wavelength range, and, a laser absorption rate in the preset wavelength range of the wear-resistant layer is lower than a laser absorption rate in the preset wavelength range of the decorative layer.

### BRIEF DESCRIPTION OF THE DRAWINGS

The drawings are provided to illustrate example embodiments described herein and are not intended to limit the scope of the present disclosure.

FIG. 1 is a flow chart showing a method for forming a lock flooring according to some embodiments.

FIG. 2 depicts a laser and a laser platform used in the local linear heat treatment step according to some embodiments.

FIG. 3 is a side cross-sectional view of a processing notch of a board-shaped material viewed along the first direction showing a substrate layer, a decorative layer, and a wear-resistant layer of the board-shaped material according to some embodiments.

FIG. 4 is a schematic view showing the local linear heat treatment of the processing notch of the board-shaped material by a first arrangement of the laser according to some embodiments.

FIG. 5 is a schematic view showing the local linear heat treatment of the processing notch of the board-shaped material by a second arrangement of the laser according to some embodiments.

FIG. 6 is a schematic view showing the local linear heat treatment of the processing notch of the board-shaped material by a third arrangement of the laser according to some embodiments.

FIG. 7 is a schematic view showing the local linear heat treatment of the processing notch of the board-shaped material by the first arrangement of the laser, and, the extrusion molding processing applied to the processing notch, according to some embodiments.

FIG. 8 is a schematic view showing the processing notch of the board-shaped material after the local linear heat treatment step and the extrusion molding processing step.

FIG. 9 is a schematic view showing a first type of the laser spot emitted by the laser.

FIG. 10 is a schematic view showing a second type of the laser spot emitted by the laser.

FIG. 11 is a block diagram illustrating the production of the second type of the laser spot.

FIG. 12 is a flow char showing a laser-based board-shaped material processing method according to some embodiments.

### DETAILED DESCRIPTION

Aspects and embodiments of the present invention will now be discussed with reference to the accompanying figures. Further aspects and embodiments will be apparent to those skilled in the art. All documents mentioned in this text are incorporated herein by reference.

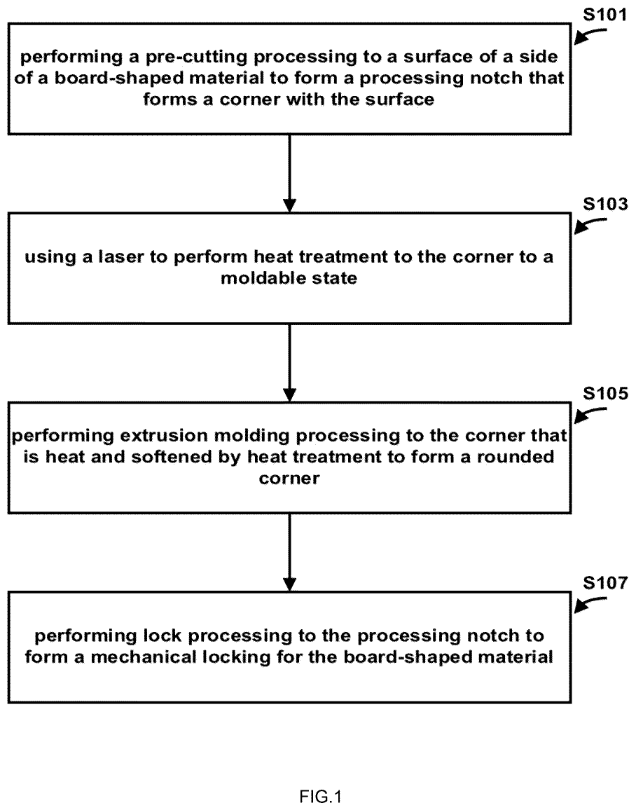

FIG. 1 is a flow chart showing a method for forming a lock flooring according to some embodiments. A lock floor refers to a type of floor panels that have at least one mechanical locking or coupling parts that allow forming a mutual locking of two floor panels. The coupling parts for forming a mutual locking may be referred to as mechanical locking parts. Two or more floor panels may be paved by using such mechanical locking parts to form the mechanical locking. For example, the shape of the coupling parts may relate to a tongue and groove connection, or may refer to any form of connection, as long as it allow two floor panels to be coupled to each other. The mechanical locking parts allow two floor panels to be coupled to each other by rotational movement or horizonal movement or both with respect to each other. In some instances, the mechanical locking parts form a tight floor joint by tension force. Generally, a lock floor or a floor panel having a mechanical locking does not need glue to realize the locking. In some instances, glue may be used to strengthen the locking of a lock floor. The mechanical locking parts are engaged with each other to form the lock engagement, and at the corners of such lock engagement, corners with a rounded shape, i.e., rounded corners, are preferred over corners with a right-angled shape. This is because corners with a right-angled shape may not provide sufficient contacting area and locking force, and therefore may result in insufficient tightness at floor joints, which may lead to increased gaps over time. Corners with a rounded shape provide a larger contacting area and a larger locking force, and is more likely to provide sufficient tightness at floor joints. A cutting tool, such as a milling cutter or a milling tool, may be used to cut edges of a floor plate to obtain rounded corners, but this destroys the top surface of the floor panel and requires precise locating as well as cumbersome processing, and therefore increases the operation costs, especially with respect to laminate flooring that has multiple layers. Also, depending on the end product requirement, the rounded corners formed at edges of the floor panels may have different angles, such as one quarter round or three fifths round. So the manufacturing tools and methods for forming rounded corners must be adaptive to various sizes and angles of rounded corners as well as different specifications of the board-shaped materials (like different hierarchy, different layer depth, different layer characteristics). Also, the locations and numbers of rounded corners may also vary with respect to end user requirements. Accordingly, the manufacturing device and method for processing board-shaped materials in order to form floor panels with mechanical locking must take above considerations into calculation.

Referring to FIG. 1, the method for forming a locking floor has several steps. The method as depicted in FIG. 1 allows forming a locking floor with mechanical locking, which not only has advantages of reduced operation costs, increased lock qualities, and increased splicing stability, but also is adaptive to fast changing consumer needs with respect to various sizes and angles of rounded corners in an efficient and cost-saving way.

Referring to FIG. 1, the step S101 is: performing a pre-cutting processing to a surface of a side of a board-shaped material to form a processing notch that forms a corner with the surface. At step S101, the pre-cutting processing may be performed by means of any suitable cutting tool configuration, such as a sawing tool, or a milling cutter. The board-shaped material to which the pre-cutting processing is applied, may be one of many small plates, and big plates may be cut, such as by sawing, into small plates. It is preferred that, a machining side of the processing notch retains certain machining tolerance such that in subsequent steps rounded corners may be formed by a laser-based board-shaped material processing device and a laser-based board-shaped material processing method. In some embodiments, the processing notch is cut downward from a top layer of the surface on the side of the board-shaped material. In some embodiments, the pre-cutting processing is applied to both sides of the board-shaped material to form two processing notches respectively. Preferably, the two processing notches both retain certain machining tolerance. In some embodiments, the processing notch includes a processing side surface and a processing base surface, and an angle is formed between the processing side surface and the processing base surface. The angle range is smaller than or equal to 90 degrees, and, the processing side surface retains certain machining tolerance. This structure of the processing notch provides flexibility of adjusting the specifications of the pre-cutting processing to be adaptive to various sizes and angles of rounded corners while affording sufficient machining tolerance. It is noted that, the pre-cutting processing at step S101 merely serve to form a processing notch, and forming a processing notch is different from forming a rounded corner directly. If a rounded corner is formed by cutting directly, the edge must be subject to hot pressing and then a corner line after the hot pressing must be precisely aligned. Here, because step S101 only involves forming a processing notch or multiple processing notches at specific locations on the board-shaped material, and the board-shaped material may be obtained by sawing big plates into small plates, therefore, it saves the efforts and costs associated with the hot pressing and aligning, and it significantly reduces the requirements for sawing accuracy as well as the operation costs and defective rates.

Still referring to FIG. 1, the step S103 is: using a laser to perform heat treatment to the corner to a moldable state. Here, at step S103, the heat treatment is performed by using the laser, so that laser beam emitted by the laser may form a laser spot on a particular location on the board-shaped material. It is noted that, using the laser to perform heat treatment to the corner to a moldable state is different using a laser to cut or separate. While laser treatment is meant for removing a material portion, laser beam is directed to cause crack formation, so the energy of the laser beam may be focused along a cutting line. In contrast, using the laser to perform heat treatment to the corner to a moldable state, requires distributing the energy of the laser beam to a certain region on the board-shaped material. The area of this region and the energy distribution within the region determine the heating performance of the step S103 of heat treatment, and consequentially determine the outcome of following steps for forming rounded corners. As mentioned above, the board-shaped material may have various specifications, such as different hierarchy, different layer depth, and different layer characteristics. As such, in order to improve the heating performance and the outcome of the rounded corners, the area of this region on the board-shaped material and the energy distribution are preferably to be adaptive to the specifications of the board-shaped material. Further, since the corner is formed by the processing notch with the surface of the board-shaped material and is heat and softened by the heat treatment by the laser, the laser treatment of the corner at the step S103 must take into considerations that the corner that is heat is subject to extrusion molding processing to form the rounded corner, and the rounded corner may have various sizes and angles depending on end product requirements. Preferably, the heat treatment performed by the laser to the corner is local linear heat treatment. Also, preferably, the local linear heat treatment adopts a linear concentrating heating method, and, the linear concentrating of the laser beam for local heating is limited to the corner. In some embodiments, the board-shaped material is movable along a transportation direction in order to facilitate the flow of operations, and, local linear heat treatment is performed by the laser to linearly heat the corners on both sides of the board-shaped material to a moldable state along the transportation direction of the board-shaped material.

Still referring to FIG. 1, the step S105 is: performing extrusion molding processing to the corner that is heat and softened by heat treatment to form a rounded corner. Here, extrusion molding processing is performed after the corner is heat and softened by the previous step of heat treatment by the laser, such that the corner, before extrusion molding processing, is in a moldable state, which is beneficial to forming a rounded corner. Specifically, the method for forming the lock floor includes performing the pre-cutting processing on the board-shaped material (in some instances, the board-sharped material is obtained by cutting big plates into small plates), and then, performing heat treatment (preferably local linear heating) to the corner formed by the pre-cutting processing, further then, performing extrusion molding processing to the corner to form a rounded corner. As such, one or more pressing wheel(s) with arc-shaped contacting surface may be adopted to shape the corner of the board-shaped material after the heat treatment step into the rounded corner. It is noted that, the whole procedure from performing the pre-cutting processing to performing heat treatment and then to performing extrusion molding processing, avoids overall heating treatment to the board-shaped material and requires only local heat treatment to prepare the corner for extrusion molding processing, thereby preventing a deformation of the board-shaped material that may be caused by overall heating treatment, greatly improving the stability of the high-quality corners. Further, because the rounded corner is formed by extrusion molding processing rather than cutting, the surface structure of the board-shaped material may be preserved, and therefore, the internal structural layer of the board-shaped material may be still covered by the surface structure and not to be exposed, which saves additional painting operation and simplifies the overall procedure, thereby reducing the production costs. In some embodiments, one or several pressing wheel tool configurations may be used to profile the corner or the edge of the board-shaped material that is heat and softened, and the board-shaped material may be displaced horizontally in a linear feeding direction by a chain or a conveyor belt. One or more pressing wheels may be used to provide vertical pressure so as to shape the corner by extrusion molding processing.

Still referring to FIG. 1, in some embodiments, with respect to the step S105 of performing extrusion molding processing to the corner, it is achieved by pressing wheel tool configurations that extrudes the softened corner by forming channels on both sides of the board-shaped material, so as to extrude the softened corner to form a rounded corner. The forming channels are formed by the contacting surface of the upper pressing wheel and the contacting surface of the lower pressing wheel, and, the contacting surface of the lower pressing wheel is designed along the axial direction according to the arc surface of the target corner, that is extruded with the corner after local heating. The two sides of the board-shaped material pass through the forming channels at the same time, and the softened corner is extruded to form the rounded corner, while, the structural layers (such as wear-resistant layer, decorative layer, and substrate layer) at the corner of the board-shaped material after extrusion and deformation are deformed as a whole to form the rounded corner. Consequentially, each structural layer of the board-shaped material is covered in turn from top to bottom, without destroying the surface structure, thereby saving subsequent chamfering and painting operations. The contacting surface of the upper pressing wheel is mainly used to provide a pressing force, while, it cooperates with the lower pressing wheel to achieve the extrusion forming. Also, the board-shaped material is transmitted and displaced in a state that it is pressed tightly, so as to avoid deviation of the board-shaped material during the extrusion process. In some embodiments, the upper pressing wheel and the lower pressing wheel are follower wheels, and the upper pressing wheel and the lower pressing wheel are driven to rotate by the board-shaped material in transmission.

Still referring to FIG. 1, with respect to the step S105 of performing extrusion molding processing, in some embodiments, a forming channel is formed at both sides of the board-shaped material after the corner is heat and softened, and the softened corner is extruded to form a rounded corner. In some embodiments, the forming channel is formed by cooperation between contacting surfaces of a pair of pressing wheels, such as an upper pressing wheel and a lower pressing wheel. The contacting surface of one pressing wheel, such as the contacting surface of the lower pressing wheel, may be designed axially to have an arc-shaped contacting surface, so that it may cooperate with the corner after local heating to perform extrusion molding processing. In some embodiments, after extrusion molding processing is performed, structural layers of the board-shaped material at the corner are extruded and deformed to form curved corners, and the internal architecture of the structural layers remain unchanged, which means the structural layers are staggered in the same order both before and after extrusion molding processing is performed, thereby greatly improving the stability of high-quality locking floor and saving production costs. In some embodiments, with respect to the step S101 of performing the pre-cutting processing, the step S103 of performing heat treatment, and the step S105 of performing extrusion molding processing, in some embodiments, the board-shaped material is moved along a transportation direction, substantially in a straight line. This arrangement keeps the length direction of the corners of the board-shaped material to be substantially the same as the transportation direction of the board-shaped material, and allows to deploy associated devices along the transportation direction nearby, such as arranging a cutting tool configuration for the pre-cutting processing, a laser heating unit for the heat treatment, and a pressing wheel tool configuration for extrusion molding processing sequentially along the transportation direction. As such, as the board-shaped material is moved along the transportation direction, a series of processing notches may be formed by the pre-cutting processing, and a series of rounded corners may be formed. Also, a conveyor belt or similar mechanism may be used to transport batches of board-shaped material (such as small plates), such that floor panels with mechanical locking system may be constructed in pipeline operations. In some embodiments, during the transportation, the board-shaped material is placed with the top surface layer facing downwardly or upwardly. The top surface layer is usually a wear-resistant layer or a decorative layer. It is noted that, tool configurations that used to perform the steps of the method for forming a locking floor may be easily adjusted to accommodate for the facing of the top surface layer of the board-shaped material.

Still referring to FIG. 1, the step S107 is: performing lock processing to the processing notch to form a mechanical locking for the board-shaped material. In some embodiments, performing lock processing includes performing roughing and finishing sequentially with respect to tenons and tongue-and-grooves, so as to complete forming a mechanical locking for the board-shaped material. The step of S107 is performed based on the processing notch that has already gone through the steps of S101, S103, and S105 sequentially. As such, the processing notch that is initially formed by the pre-cutting processing has a corner or an edge with a right-angle shape, and the board-shaped material generally has multiple structural layers that are displaced in a specific order. By heating and softening the corner and then applying extrusion molding processing, such as by pressing wheel tool configurations, the corner with a right-angle shape of the processing notch is turned into a rounded corner, and the size and angle of the rounded corner may be adjusted, such as one quarter round or three fifths round, by modifying the setting of the pressing wheel tool configurations. Also, the machining tolerance that the processing notch retains at the step S101 of performing the pre-cutting processing, may be determined base on the actual shape of the locking, such as the sizes of tenons and tongue-and-grooves.

Still referring to FIG. 1, in some embodiments, after the step S105 of performing extrusion molding processing and before the step S107 of performing lock processing, a cooling procedure may be arranged, so that the rounded corner that is extruded and deformed may have sufficient time to cool down to stabilize the shape. A suitable cooling device may be used to place the target corner under a specific cooling temperature. The specific cooling temperature can be set according to the actual demand. The cooling procedure may be applied to the board-shaped material as a whole or locally to a target region on the board-shaped material. The cooling procedure takes into consideration that the rounded corner that goes through the extrusion molding processing may still maintain a relatively high temperature, and such high temperature may cause deforming of the rounded corner to happen during the lock processing. By cooling down the rounded corner after the extrusion molding processing, the shape of the rounded corner may be stabilized.

With reference to the method and illustrated steps of FIG. 1, the method for forming a locking floor avoids using a cutting tool, such as a milling cutter, to directly cut an edge of a board-shaped material to form a rounded corner, i.e., a corner having a rounded shape, and instead, performs a pre-cutting processing to form a processing notch then performs heat treatment to put a target corner in a moldable state, such that the corner is softened, making it convenient to perform extrusion molding processing to the softened corner to form a rounded corner. As such, by using extrusion molding processing rather than cutting, the surface structural layer may be preserved and the internal structural layers of the board-shaped material are not exposed. Also, since the rounded corner is formed only after the pre-cutting processing and the heat treatment, this means that the board-shaped material may be obtained by sawing bigger plates into smaller plates and this sawing operation will not affect the forming of rounded corners, thereby reducing the precision requirement for the sawing operation. Further, as structural layers of the board-shaped material at the corner are extruded and deformed to form curved corners, the internal architecture of the structural layers remain unchanged, and therefore, the structural layers are staggered in the same order both before and after extrusion molding processing is performed. As such, by preserving the internal architecture of the structural layers, the internal structural layers of the board-shaped material are prevented from being exposed, and the stability of the quality of the rounded corner is greatly improved. In contrast, conventional techniques that rely on cutting tools to form rounded corners will destroy the internal architecture and remove top surface layers, and therefore will cause additionally chamfering operations and painting operations. Accordingly, the method for forming a locking floor as depicted in FIG. 1, has advantages of improving manufacturing rounded corners for mechanical locking systems of floor panels, not only reducing the precision requirements of the plate sawing and making it conducive to improving the stability of the quality of the edges of floor plates, but also avoiding the exposure of structural layers inside floor plates and saving additional operation costs of chamfering and painting.

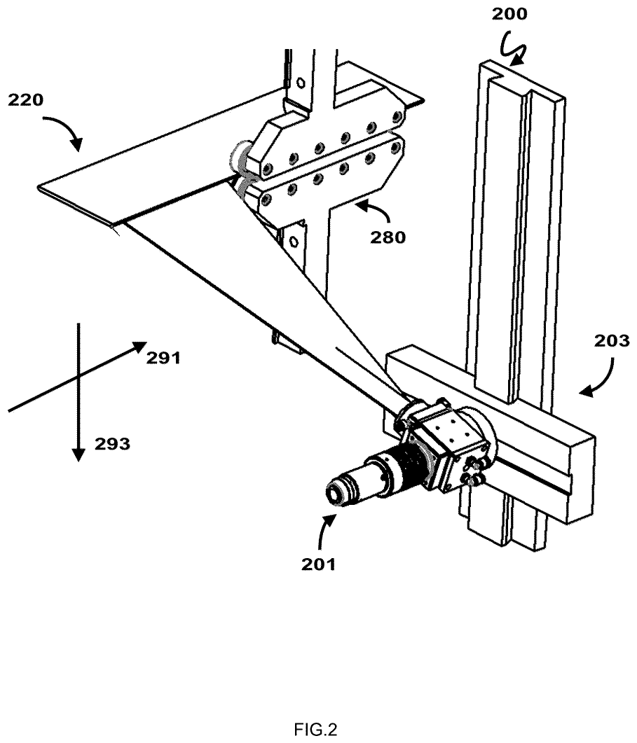

FIG. 2 depicts a laser and a laser platform used in the local linear heat treatment step according to some embodiments. As described above, the step of using a laser to perform heat treatment to the corner to a moldable state, preferably, uses local linear heat treatment. The local linear heat treatment generally adopts a linear concentrating heating method and serves to heat and soften the corner that is formed by the pre-cutting processing such that the corner may be subject to subsequent extrusion molding processing to be shaped into a rounded corner. As such, the local linear heat treatment step is critical in that it determines the heating performance and the outcome of forming the rounded corner. The board-shaped material may have various specifications, such as different hierarchy, different layer depth, and different layer characteristics. For instance, structural layers of the board-shaped material usually have different heat absorption rates, and this means that two structural layers that are heat by the same laser beam may have different temperature increasements. Also, depending on end product requirements, the rounded corner that is finally formed may have various sizes and angles, such as one quarter round or three fifths round. While pressing wheel tool configurations used in the step of performing extrusion molding processing may be adjusted to profile the corner or the edge of the board-shaped material to meet the actual shape of the mechanical locking, the local linear heat treatment step still needs to provide sufficient adaptiveness such that the heating region on the board-shaped material and the energy distribution within the heating region may be adjusted in order to facilitate the pipeline operations. For example, the board-shaped material may be one of many small platers, that may be obtained by sawing big plates into small plates, and these small plates may be displaced on a chain or a conveyor belt or a transportation system, such that small plates are moved along a transportation direction. As small plates including the board-shaped material are moved along the transportation direction, a series of processing notches may be formed by the pre-cutting processing, then local linear heat treatment step is performed to a series of corners, and eventually, a series of rounded corners. This can be achieved by arranging a series of devices along the transportation direction, for performing each step for forming the locking floor respectively. For example, a cutting tool configuration, such as a sawing tool, or a milling cutter, is used for performing the pre-cutting processing, and a pressing wheel tool configuration is used for performing extrusion molding processing. Here, a laser and a laser platform are used in the local linear heat treatment step for performing heat treatment to the corner to a moldable state. It is noted that, more than one device may be used for a single step, such as using two pressing wheel tool configuration to form two corners on both sides of the board-shape material respectively. Accordingly, depending on details of the pipelined operations for forming batches of floor panels, the local linear heat step may need to adapt the heating region on the board-shaped material or adjust the energy distribution so as to optimize the overall efficiency, while taking into considerations of adaptiveness to various specifications of the board-shaped material.

Referring to FIG. 2, a laser-based board-shaped material processing device 200 includes a laser 201 and a laser platform 203. The board-shaped material processing device 200 is configured for performing the local linear heat treatment, such as the step S103 of performing heat treatment to the corner to a moldable state of the method for forming a locking floor as depicted in FIG. 1. FIG. 2 also shows that a pressing wheel tool configuration 280 for performing extrusion molding processing is displaced. A board-shaped material 220 is movable along a transportation direction 291, and is first processed by the laser-based board-shaped material processing device 200 for the local linear heat treatment, then processed by the pressing wheel tool configuration 280 for the extrusion molding processing. While not shown in FIG. 2, a cutting tool configuration for performing the pre-cutting processing is displaced, and the board-shaped material 220 is processed by the cutting tool configuration for the pre-cutting processing before the board-shaped material 220 is processed by the laser-based board-shaped material processing device 200.

Still referring to FIG. 2, the laser 201 is fixed on the laser platform 203. The board-shaped material 220 that includes a substrate layer, a decorative layer, and a wear-resistant layer is movable along a first direction 291 on a first plane. Here, the transportation direction 291 along which the board-shaped material 220 is transported and processed in sequenced by a series of tool configurations is the first direction 291. Along a second direction 293 perpendicular to the first plane are the substrate layer, the decorative layer, and the wear-resistant layer of the board-shaped material 220 in turn. It is noted that the board-shaped material 220 has multiple layers, such as a laminated floor panel, and the illustrated number and internal hierarchy of the structural layers of the board-shaped material 220 are illustrative only. The second direction 293 indicates how the structural layers of the board-shaped material 220 are staggered. In some embodiments, the first direction 291 is a horizontal direction showing towards which direction the board-shaped material 220 is moved horizontally, and, the second direction 293 is a perpendicular direction showing the top surface layer of the board-shaped material 220 is facing downwardly or upwardly. Generally, the wear-resistant layer of the board-shaped material 220 is used for the top surface layer, and in FIG. 2, the second direction 293 shows that the wear-resistant layer is facing downwardly, in other words, the decorative layer is placed on top of the wear-resistant layer. In some embodiments, the second direction 293 may point to other directions, such as opposite to what is shown in FIG. 2, and this means that the wear-resistant layer is facing upwardly with the decorative layer placed below the wear-resistant layer.

Still referring to FIG. 2, the laser platform 203 is operable to move the laser 201 back and forth in the second direction 293 and to rotate the laser 201 on a second plane that is perpendicular to both the first plane and the first direction 291. The board-shaped material 220 includes a processing notch. The processing notch forms a first corner and a second corner with a surface of the board-shaped material 220. All of the first corner is located in the substrate layer, and, the second corner is simultaneously located in the substrate layer, the decorative layer, and the wear-resistant layer. The first direction 291 indicates the transportation direction of the board-shaped material 220, and the first plane represents the plane on which the board-shaped material 220 is moved. The second direction 293 indicates how the board-shaped material 220 is faced, and the second plane represents the plane on which the laser 201 rotates. The laser beam emitted by the laser 201 covers a region on the board-shaped material 220, like a laser spot that covers a region of the board-shaped material 220, therefore, the portion of the board-shaped material 220 covered by the laser spot absorbs energy from the laser beam and has a temperature increasing. By moving the laser 201 back and forth in the second direction 293, and by rotating the laser 201 on the second plane, the propagation direction of the laser beam emitted by the laser 201 may be adjusted, and, the distance from the laser 201 to the region on the board-shaped material 220 covered by the lase spot emitted by the laser 201 may also be adjusted, and further, the size and location of the laser spot on the board-shaped material 220 may also be adjusted. It is noted that, the size of the laser spot, i.e., the size of the heat region by the laser 201 on the board-shaped material 220 may remain unchanged, while, one can operate the laser platform 203 to change the location of the heat region, in other words, determine what portions of the board-shaped material 220 are heat by the local linear heat treatment by the laser 201. For example, the laser spot may be a circular spot, or a rectangular spot, and the area covered by the laser spot on the board-shaped material 220, may overlap with one or more structural layers of the board-shaped material 220. For example, if the laser spot is a rectangular spot, the area covered by the laser spot on the board-shaped material 220 is generally in the shape of a rectangular, and the structural layers of the board-shaped material 220 are staggered in the second direction 293 with their length directions substantially parallel to the first direction 291. As such, the heat region that is heat by the laser spot may overlap with one or more structural layers, and the length direction of the rectangular shape of the laser spot may be substantially parallel to the length directions of the structural layers. This means that the energy emitted by the laser 201 is absorbed by the portion of the board-shaped material 220 that is covered by the rectangular laser spot, and, by moving the laser 201 as well as rotating the laser 201, the rectangular laser spot is moved with respect to the board-shaped material 220 in a relative manner, and therefore results in changes of heat performance. As such, the operator of the board-shaped material processing device 200 can conveniently adapt the heat region on the board-shaped material 220 and adjust the energy distribution to optimize the overall efficiency, which will be described further in details below.

Still referring to FIG. 2, the board-shaped material processing device 200 is configured for, operating the laser platform 203 such that a laser spot emitted by the laser 201 covers a portion of a part of the substrate layer corresponding to the second corner and a totality of a part of the decorative layer corresponding to the second corner, and then, using the laser 201 to perform heat treatment so as to heat a part of the wear-resistant layer corresponding to the second corner to a moldable state, such that extrusion molding processing is applicable to the second corner to form a rounded corner. By operating the laser platform 203, one can move the laser 201 back and forth in the second direction 293 and rotate the laser 201 on the second plane that is perpendicular to both the first plane and the first direction 291, along which the board-shaped material 220 is transported. Also, the structural layers of the board-shaped material 220 are staggered in a specific order with respect to the second direction 293, and that is, the substrate layer, the decorative layer, and the wear-resistant layer of the board-shaped material 220 are along the second direction 293 in turn. In other words, along the second direction 293, the substrate layer is placed on top of the decorative layer, and the decorative layer is place on top of the wear-resistant layer. Here, the wear-resistant layer refers to a structural layer that has high durability, usually on its exposed side. In some embodiments, the wear-resistant layer may be formed of translucent materials, and has a relatively low absorption rate for the laser beam, so that one can see through the wear-resistant layer to observe the decorative layer. The decorative layer refers to a structural layer that is designed to provide decorative appearance for the floor panel after the board-shaped material 220 is processed. The substrate layer is the core component of a laminated floor panel, which may use wood or plant fibers as raw materials. A laminate flooring typically has three layers or four layers, and the internal architecture of the layers typically is formed by a substrate layer, a decorative layer, and a wear-resistant layer.

Still referring to FIG. 2, by operating the laser platform 203, the laser spot emitted by the laser 201 is set to overlap with the board-shaped material 220 according to a specific design, that is, the laser spot covers a portion of a part of the substrate layer corresponding to the second corner and a totality of a part of the decorative layer corresponding to the second corner. It is noted that, the processing notch forms the first corner and the second corner with the surface of the board-shaped material 220. And, all of the first corner is located in the substrate layer, and, the second corner is simultaneously located in the substrate layer, the decorative layer, and the wear-resistant layer. In this regard, the pre-cutting processing that forms the processing notch must cut into the substrate layer to form the first corner. Despite that the first corner may have a straight shape or a curved shape, all of the first corner must be in the substrate layer, and this means that, the processing notch has an edge defined by the first corner that is totally inside the substrate layer. While, the second corner is simultaneously located in the substrate layer, the decorative layer, and the wear-resistant layer, as such, the pre-cutting processing that forms the processing notch must cut through the substrate layer, the decorative layer, and the wear-resistant layer to form the second corner. This means that the processing notch has an edge defined by the second corner that is formed by cutting through the substrate layer, the decorative layer, and the wear-resistant layer. In this regard, the edge of the processing notch as defined by the second corner, if taken a cross-sectional view of the board-shaped material 220 at the second corner, shows the internal architecture of the board-shaped material 220, which indicates that the substrate layer, the decorative layer, and the wear-resistant layer are placed in turn along the second direction 293. Accordingly, a part of the substrate layer corresponding to the second corner represents a part of the edge of the processing notch that is defined by the second corner and belongs to the substrate layer. In other words, a part of the substrate layer corresponding to the second corner refers to an overlapping between the substrate layer and the second corner. And, a portion of a part of the substrate layer corresponding to the second corner defines, only a portion, rather than a whole, of the part of the substrate layer corresponding to the second corner. As such, by defining that the laser spot covers a portion of a part of the substrate layer corresponding to the second corner, this means that another portion of the part of the substrate layer corresponding to the second corner is not covered by the laser spot. In contrast to having a portion of a part of the substrate layer corresponding to the second corner covered by the laser spot, the laser spot covers a totality of a part of the decorative layer corresponding to the second corner. This means that, a part of the edge of the processing notch that is defined by the second corner and belongs to the decorative layer, is, in a whole, covered by the laser spot. In other worlds, an overlapping between the decorative layer and the second corner is totally covered by the laser spot emitted by the laser 201. This design of arranging the laser spot to partially cover a part of the substrate layer corresponding to the second corner and fully cover a part of the decorative layer corresponding to the second corner, is beneficial to improving the heat performance and overall efficiency, which will be described further in details below.

Still referring to FIG. 2, because the laser spot covers a portion of a part of the substrate layer corresponding to the second corner and a totality of a part of the decorative layer corresponding to the second corner, during the local linear heat treatment step, the laser heats the decorative layer fully while heats the substrate layer limitedly. The decorative layer, that is designed to provide decorative appearance, has a relatively high absorption rate for the lase beam, while, the wear-resistant layer, that is typically formed of translucent materials, has a relatively low absorption rate for the laser beam. Therefore, by arranging the laser spot to cover a totality of a part of the decorative layer corresponding to the second corner, this allows the decorative layer to better absorb the energy, and consequentially have a faster increase in temperature. While, by arranging the laser spot to cover only a portion of a part of the substrate layer corresponding to the second corner, this helps to control the laser spot to cover a restricted region of the substrate layer, and therefore prevents the laser spot from overlapping with the first corner. To this regard, by preventing the laser spot from fully covering the part of the substrate layer corresponding to the second corner, this restricts the laser spot to stay within the edge of the processing notch defined by the second corner, and therefore helps to prevent the laser spot from overlapping with the edge of the processing notch defined by the first corner, thereby helping to prevent the high-energy laser from damaging the material. Accordingly, most of the energy is absorbed by the decorative layer, and, when the temperature of the decorative layer increases, the decorative layer by heat conduction, causes the temperature of neighboring structural layers to increase, including causing the temperature of the wear-resistant layer to increase. Also, the substrate layer is heated in a limited way, with only a portion of a part of the substrate layer corresponding to the second corner heated. Therefore, the local linear heat treatment is achieved mainly based on the absorption of the laser beam by the decorative layer and the heat conduction from the decorative layer to the wear-resistant layer as well as the substrate layer. This helps to maintain the internal architecture of the board-shaped material 220 unchanged, and prevent the wear-resistant layer and the substrate layer from cracking after receiving deforming pressure. In subsequent procedures, the wear-resistant layer and the substrate layer in a sharp cornering position, like at the edge of the processing notch defined by the second corner, may be subject to deforming pressure, such as the step S107 of performing lock processing (including performing roughing and finishing sequentially to the processing notch), and this portion of the wear-resistant layer and the substrate layer in the sharp cornering position may be removed due to deforming pressure, thereby affecting the appearance and quality of the floor panel. In order to maintain the internal architecture of the board-shaped material 220 unchanged, the heat applied to the wear-resistant layer and the heat applied to the substrate layer must be carefully calibrated and controlled. Such calibration and controlling must take into considerations of the material characteristics of the wear-resistant layer itself, such as its absorption rate for the laser beam, and may be achieved by the above-mentioned arrangement of the laser spot according to a specific design. For example, the laser spot may be arranged to enlarge or shrink the portion of the part of the substrate layer corresponding to the second corner that is covered by the laser spot, and therefore controls the temperature increasing speed of the substrate layer with respect to the temperature increasing speed of the wear-resistant layer, which is generally caused by the heat conduction from the decorative layer.

Still referring to FIG. 2, it should be understood that, while the wear-resistant layer usually adopts a translucent material, such as Polyvinyl chloride (PVC), that usually has a low absorption rate for the laser beam, however, the present disclosure provides a laser-based board-shaped material processing device, a laser-based board-shaped material processing system, and a laser-based board-shaped material processing method, which may be effectively applied to floor panels whose wear-resistant layers have a higher absorption rate for the laser beam. This is because the local linear heat treatment is achieved mainly based on the absorption of the laser beam by the decorative layer and the heat conduction from the decorative layer to the wear-resistant layer as well as the substrate layer. Therefore, regardless of whether the wear-resistant layer has a high absorption rate or a low absorption rate for the laser beam, the local linear heat treatment can still effectively cause the temperature of the decorative layer and the temperature of the wear-resistant layer to increase, so as to heat a part of the wear-resistant layer corresponding to the second corner to a moldable state. As such, after the local linear heat treatment, extrusion molding processing is applicable to the second corner to form a rounded corner. This affords flexibility in choosing the materials used for the wear-resistant layer.

In light of above, the laser-based board-shaped material processing device 200 as depicted in FIG. 2, provides an operative mechanism for moving and rotating the laser 201 through operating the laser platform 203, so as to arrange the laser spot emitted by the laser 201 to cover specific regions of the board-shaped material 220 according to a specific design, that is, arranging the laser spot to cover a portion of a part of the substrate layer corresponding to the second corner and a totality of a part of the decorative layer corresponding to the second corner. This means that, in accordance with the specific design, the laser spot emitted by the laser 201, is arranged to partially cover a part of the substrate layer corresponding to the second corner and fully cover a part of the decorative layer corresponding to the second corner. Therefore, the arrangement of the laser spot with respect to the spatial relationships of the structural layers of the board-shaped material 220 provides a well designed heating mechanism for performing the local linear heat treatment. The heating mechanism is mainly based on the absorption of the laser beam by the decorative layer and the heat conduction from the decorative layer to the wear-resistant layer as well as the substrate layer, and includes heating the decorative fully while heating the substrate layer in a limited way. As such, the heating mechanism helps to maintain the internal architecture of the board-shaped material 220 unchanged, and prevent the wear-resistant layer and the substrate layer from cracking after receiving deforming pressure, while, also affords calibration and controlling with respect to the heat applied to the wear-resistant layer and the heat applied to the substrate layer. The arrangement of the lase spot and the associated heating mechanism provides great adaptiveness to various specifications of the board-shaped material 220 as well as different sizes and angles of the rounded corners formed. For example, the beam mode of the laser spot may be changed to affect the energy distribution within the laser spot (such as s-mode, d-mode, or any suitable beam profile), the angle of the propagation direction of the laser beam emitted by the laser 201 may be changed to affect the location and size of the laser spot, and, the distance from the laser 201 to the processing notch may also be changed to improve the heating performance. For another example, the laser spot may be arranged to enlarge or shrink the portion of the part of the substrate layer corresponding to the second corner that is covered by the laser spot, and therefore controls the temperature increasing speed of the substrate layer with respect to the temperature increasing speed of the wear-resistant layer, which is generally caused by the heat conduction from the decorative layer. For still another example, the heating time by the laser beam may be increased or deceased, so as to adapt to the material characteristics of the structural layers, thereby softening the corner to a moldable state while preventing the materials from carbonization. In sum, the adaptiveness provided by the arrangement of the lase spot and the associated heating mechanism, has advantages of precise positioning, controllable heating, adaptation to material characteristics, preventing cracking due to deformation pressure, softening the material while avoiding material carbonization, meeting the processing needs of different machining tolerances, various specifications of floor panels such as rounded corners of different sizes and angles, and effectively improving overall efficiency. Accordingly, the laser-based board-shaped material processing device 200 has advantages of reduced operation costs, increased lock qualities, and increased splicing stability, and is adaptive to fast changing consumer needs with respect to various sizes and angles of rounded corners in an efficient and cost-saving way.

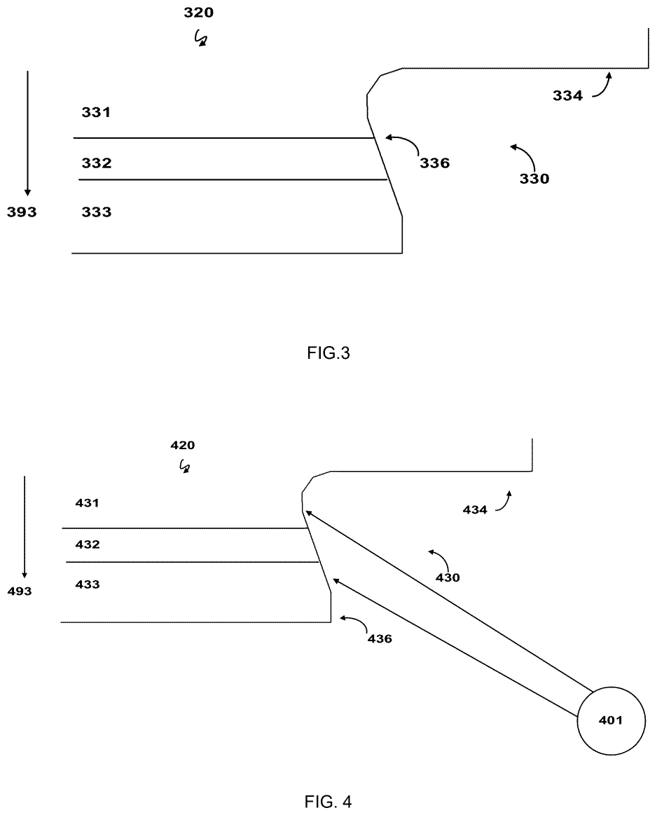

FIG. 3 is a side cross-sectional view of a processing notch of a board-shaped material viewed along the first direction showing a substrate layer, a decorative layer, and a wear-resistant layer of the board-shaped material according to some embodiments. FIG. 3 depicts a board-shaped material 320 that has three structural layers, i.e., a substrate layer 331, a decorative layer 332, and a wear-resistant layer 333. along a second direction 393 perpendicular to the first plane are the substrate layer 331, the decorative layer 332, and the wear-resistant layer 333 of the board-shaped material 320 in turn. The board-shaped material 320 includes a processing notch 330. The processing notch 330 forms a first corner 334 and a second corner 336 with a surface of the board-shaped material 320. All of the first corner 334 is located in the substrate layer 331. The second corner 336 is simultaneously located in the substrate layer 331, the decorative layer 332, and the wear-resistant layer 333. The board-shaped material processing device is configured for, operating the laser platform such that a laser spot emitted by the laser covers a portion of a part of the substrate layer 331 corresponding to the second corner 336 and a totality of a part of the decorative layer 332 corresponding to the second corner 336, and then, using the laser to perform heat treatment so as to heat a part of the wear-resistant layer 333 corresponding to the second corner 336 to a moldable state, such that extrusion molding processing is applicable to the second corner 336 to form a rounded corner.

Referring to FIG. 3, the processing notch 330 is formed by a pre-cutting processing, by a cutting tool configuration, such as a sawing tool, or a milling cutter. The pre-cutting processing that forms the processing notch 330 must cut into the substrate layer 331 to form the first corner 334. While FIG. 3 shows that the first corner 334 is generally in a straight shape, in some embodiments, the first corner 334 may be in a curved shape or any other shape, as long as the first corner 334 remains in the substrate layer 331. Despite that the first corner 334 may have a straight shape or a curved shape, all of the first corner 334 must be in the substrate layer 331, and this means that, the processing notch 330 has an edge defined by the first corner 334 that is totally inside the substrate layer 331. While, the second corner 336 is simultaneously located in the substrate layer 331, the decorative layer 332, and the wear-resistant layer 333, as such, the pre-cutting processing that forms the processing notch 330 must cut through the substrate layer 331, the decorative layer 332, and the wear-resistant layer 333 to form the second corner 336. This means that the processing notch 330 has an edge defined by the second corner 336 that is formed by cutting through the substrate layer 331, the decorative layer 332, and the wear-resistant layer 333. In this regard, the edge of the processing notch 330 as defined by the second corner 336, if taken a cross-sectional view of the board-shaped material 320 at the second corner 336, as depicted in FIG. 3, shows the internal architecture of the board-shaped material 320, which indicates that the substrate layer 331, the decorative layer 332, and the wear-resistant layer 333 are placed in turn along the second direction 393. Accordingly, a part of the substrate layer 331 corresponding to the second corner 336 represents a part of the edge of the processing notch 330 that is defined by the second corner 336 and belongs to the substrate layer 331. In other words, a part of the substrate layer 331 corresponding to the second corner 336 refers to an overlapping between the substrate layer 331 and the second corner 336. And, a portion of a part of the substrate layer 331 corresponding to the second corner 336 defines, only a portion, rather than a whole, of the part of the substrate layer 331 corresponding to the second corner 336. As such, by defining that the laser spot covers a portion of a part of the substrate layer 331 corresponding to the second corner 336, this means that another portion of the part of the substrate layer 331 corresponding to the second corner 336 is not covered by the laser spot. In contrast to having a portion of a part of the substrate layer 331 corresponding to the second corner 336 covered by the laser spot, the laser spot covers a totality of a part of the decorative layer 332 corresponding to the second corner 336. This means that, a part of the edge of the processing notch 330 that is defined by the second corner 336 and belongs to the decorative layer 332, is, in a whole, covered by the laser spot. In other worlds, an overlapping between the decorative layer 332 and the second corner 336 is totally covered by the laser spot emitted by the laser. This design of arranging the laser spot to partially cover a part of the substrate layer 331 corresponding to the second corner 336 and fully cover a part of the decorative layer 332 corresponding to the second corner 336, is beneficial to improving the heat performance and overall efficiency, which will be described further in details below.

Still referring to FIG. 3, the processing notch 330 forms the first corner 334 and the second corner 336 with the surface of the board-shaped material 320. The edge of the processing notch 330 defined by the first corner 334 meets the edge of the processing notch 330 defined by the second corner 336 in the substrate layer 331. By arranging the laser spot to cover only a portion of a part of the substrate layer 331 corresponding to the second corner 336, this helps to control the laser spot to cover a restricted region of the substrate layer 331, and therefore prevents the laser spot from overlapping with the first corner 334. To this regard, by preventing the laser spot from fully covering the part of the substrate layer 331 corresponding to the second corner 336, this restricts the laser spot to stay within the edge of the processing notch 330 defined by the second corner 336, and therefore helps to prevent the laser spot from overlapping with the edge of the processing notch 330 defined by the first corner 334, thereby helping to prevent the high-energy laser from damaging the material. Accordingly, most of the energy is absorbed by the decorative layer 332, and, when the temperature of the decorative layer 332 increases, the decorative layer 332 by heat conduction, causes the temperature of neighboring structural layers to increase, including causing the temperature of the wear-resistant layer 333 to increase. Also, the substrate layer 331 is heated in a limited way, with only a portion of a part of the substrate layer 331 corresponding to the second corner 336 heated. Therefore, the local linear heat treatment is achieved mainly based on the absorption of the laser beam by the decorative layer 332 and the heat conduction from the decorative layer 332 to the wear-resistant layer 333 as well as the substrate layer 331. This helps to maintain the internal architecture of the board-shaped material 320 unchanged, and prevent the wear-resistant layer 333 and the substrate layer 331 from cracking after receiving deforming pressure. Accordingly, a specific design is achieved, and the specific design defines that, the laser spot emitted by the laser, is arranged to partially cover a part of the substrate layer 331 corresponding to the second corner 336 and fully cover a part of the decorative layer 332 corresponding to the second corner 336. Therefore, the arrangement of the laser spot with respect to the spatial relationships of the structural layers of the board-shaped material 320 provides a well designed heating mechanism for performing the local linear heat treatment. The heating mechanism is mainly based on the absorption of the laser beam by the decorative layer 332 and the heat conduction from the decorative layer 332 to the wear-resistant layer 333 as well as the substrate layer 331, and includes heating the decorative fully 332 while heating the substrate layer 333 in a limited way. As such, the heating mechanism helps to maintain the internal architecture of the board-shaped material 320 unchanged, and prevent the wear-resistant layer 333 and the substrate layer 331 from cracking after receiving deforming pressure, while, also affords calibration and controlling with respect to the heat applied to the wear-resistant layer 333 and the heat applied to the substrate layer 331. The arrangement of the lase spot and the associated heating mechanism provides great adaptiveness to various specifications of the board-shaped material 320 as well as different sizes and angles of the rounded corners formed. For example, the laser spot may be arranged to enlarge or shrink the portion of the part of the substrate layer 331 corresponding to the second corner 336 that is covered by the laser spot, and therefore controls the temperature increasing speed of the substrate layer 331 with respect to the temperature increasing speed of the wear-resistant layer 333, which is generally caused by the heat conduction from the decorative layer 332.

Referring to FIG. 1, FIG. 2, and FIG. 3, a laser-based board-shaped material processing device is provided. The board-shaped material processing device includes a laser and a laser platform. The laser is fixed on the laser platform. A board-shaped material that includes a substrate layer, a decorative layer, and a wear-resistant layer is movable along a first direction on a first plane. Along a second direction perpendicular to the first plane are the substrate layer, the decorative layer, and the wear-resistant layer of the board-shaped material in turn. The laser platform is operable to move the laser back and forth in the second direction and to rotate the laser on a second plane that is perpendicular to both the first plane and the first direction. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. The board-shaped material processing device is configured for, operating the laser platform such that a laser spot emitted by the laser covers a portion of a part of the substrate layer corresponding to the second corner and a totality of a part of the decorative layer corresponding to the second corner, and then, using the laser to perform heat treatment so as to heat a part of the wear-resistant layer corresponding to the second corner to a moldable state, such that extrusion molding processing is applicable to the second corner to form a rounded corner. The board-shaped material processing device may be used in a method for forming floor panels with mechanical locking systems, and specifically used for local linear heat treatment step so as to prepare a corner of a processing notch with a right-angled shape ready for extrusion molding processing that shapes the corner into a rounded corner. Further, through precise positioning, the heat absorption efficiency of the decorative layer can be ensured, the process time can be shortened, and a part of the substrate layer can be heated to avoid deformation and cracking. In order to achieve precise positioning, two operational dimensions of the laser platform need to be utilized, i.e., the laser platform being operable to move the laser back and forth in the second direction and to rotate the laser on a second plane that is perpendicular to both the first plane and the first direction. The laser-based board-shaped material processing device has advantages of reduced operation costs, increased lock qualities, and increased splicing stability, and is adaptive to fast changing consumer needs with respect to various sizes and angles of rounded corners in an efficient and cost-saving way.

In some example embodiments, the decorative layer and the laser are positioned at two opposite sides of the wear-resistant layer in the second direction respectively. The board-shaped material may be placed with the top surface layer, i.e., the wear-resistant layer, facing upwardly or downwardly or any suitable direction. By defining that the laser is movable back and forth in the second direction, and by defining that along the second direction perpendicular to the first plane are the substrate layer, the decorative layer, and the wear-resistant layer of the board-shaped material in turn, therefore, the relative positional relationships in the second direction between the laser and the structural layers of the board-shaped material may be established, and such relative positional relationships may fit into any way of placing the board-shaped material. In some examples, the second direction is parallel to the gravity force direction, and the board-shaped material is placed along a plane perpendicular to the direction of gravity. In some examples, the second direction may deviate a little from the direction of gravity, like 10 degrees, and still, the above-mentioned laser-based board-shaped material processing device may still manufacture rounded corners in an efficient and cost-saving way. Here, the decorative layer and the laser are positioned at two opposite sides of the wear-resistant layer in the second direction respectively, this means that the laser beam emitted by the laser comes from below the wear-resistant layer in the second direction to be irradiated on the wear-resistant layer. When the second direction is parallel to the direction of gravity, the laser beam is designed to irradiate the wear-resistant layer from the bottom up, which is the situation when the wear-resistant layer is placed downward. This specific placement of the laser and the decorative layer along the second direction helps to make sure that the decorative layer receives most of the energy by the laser, especially when the wear-resistant layer is formed of translucent materials with respect to the laser beam. Further, since the laser beam comes from below the wear-resistant layer in the second direction, this specific placement helps to restrict the laser spot by the laser to cover a portion of a part of the substrate layer corresponding to the second corner, and therefore helps to prevent the laser spot from overlapping with the edge of the processing notch defined by the first corner, thereby helping to prevent the high-energy laser from damaging the material.

In some example embodiments, a relative distance between the laser and the decorative layer in the second direction is larger than a relative distance between the laser and the wear-resistant layer in the second direction. By defining that the laser is movable back and forth in the second direction, and by defining that along the second direction perpendicular to the first plane are the substrate layer, the decorative layer, and the wear-resistant layer of the board-shaped material in turn, therefore, the relative positional relationships in the second direction between the laser and the structural layers of the board-shaped material may be established, and such relative positional relationships may fit into any way of placing the board-shaped material. In some examples, the second direction is parallel to the gravity force direction, and the board-shaped material is placed along a plane perpendicular to the direction of gravity. In some examples, the second direction may deviate a little from the direction of gravity, like 10 degrees, and still, the above-mentioned laser-based board-shaped material processing device may still manufacture rounded corners in an efficient and cost-saving way. Here, a relative distance between the laser and the decorative layer in the second direction is larger than a relative distance between the laser and the wear-resistant layer in the second direction, and, this means that the laser beam emitted by the laser comes from below the wear-resistant layer in the second direction to be irradiated on the wear-resistant layer. This helps to make sure that the decorative layer receives most of the energy by the laser, especially when the wear-resistant layer is formed of translucent materials with respect to the laser beam. Further, since the laser beam comes from below the wear-resistant layer in the second direction, this specific placement helps to restrict the laser spot by the laser to cover a portion of a part of the substrate layer corresponding to the second corner, and therefore helps to prevent the laser spot from overlapping with the edge of the processing notch defined by the first corner, thereby helping to prevent the high-energy laser from damaging the material.

In some example embodiments, a relative distance between the laser and the decorative layer in the second distance is essentially zero, or, the decorative layer and the laser are both positioned at a same side of the wear-resistant layer in the second direction. By defining that the laser is movable back and forth in the second direction, and by defining that along the second direction perpendicular to the first plane are the substrate layer, the decorative layer, and the wear-resistant layer of the board-shaped material in turn, therefore, the relative positional relationships in the second direction between the laser and the structural layers of the board-shaped material may be established, and such relative positional relationships may fit into any way of placing the board-shaped material. In some examples, the second direction is parallel to the gravity force direction, and the board-shaped material is placed along a plane perpendicular to the direction of gravity. In some examples, the second direction may deviate a little from the direction of gravity, like 10 degrees, and still, the above-mentioned laser-based board-shaped material processing device may still manufacture rounded corners in an efficient and cost-saving way.

In some example embodiments, the board-shaped material processing device is further configured for, operating the laser platform such that the laser spot emitted by the laser covers is spaced away from a part of the substrate layer corresponding to the first corner. As such, by arranging the laser spot to cover only a portion of a part of the substrate layer corresponding to the second corner, and by defining that the laser spot emitted by the laser covers is spaced away from a part of the substrate layer corresponding to the first corner, this helps to control the laser spot to cover a restricted region of the substrate layer, and therefore prevents the laser spot from overlapping with the first corner. To this regard, by preventing the laser spot from fully covering the part of the substrate layer corresponding to the second corner, this restricts the laser spot to stay within the edge of the processing notch defined by the second corner, and therefore helps to prevent the laser spot from overlapping with the edge of the processing notch defined by the first corner, thereby helping to prevent the high-energy laser from damaging the material. Accordingly, most of the energy is absorbed by the decorative layer, and, when the temperature of the decorative layer increases, the decorative layer by heat conduction, causes the temperature of neighboring structural layers to increase, including causing the temperature of the wear-resistant layer to increase. Also, the substrate layer is heated in a limited way, with only a portion of a part of the substrate layer corresponding to the second corner heated. Therefore, the local linear heat treatment is achieved mainly based on the absorption of the laser beam by the decorative layer and the heat conduction from the decorative layer to the wear-resistant layer as well as the substrate layer. This helps to maintain the internal architecture of the board-shaped material unchanged, and prevent the wear-resistant layer and the substrate layer from cracking after receiving deforming pressure.

In some example embodiments, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer. As such, the operation of the laser may be adjusted by changing the preset working power and the preset working time length so as to be adapted to a material characteristic of the wear-resistant layer and a size of the wear-resistant layer, thereby improving overall efficiency.

In some example embodiments, the board-shaped material processing device is further configured for, operating the laser platform so as to locate the part of the decorative layer corresponding to the second corner at a geometric center of the laser spot emitted by the laser. As such, by locating the part of the decorative layer corresponding to the second corner at a geometric center of the laser spot emitted by the laser, the heating performance is improved and overall efficiency is optimized. The precise locating may be achieved by utilizing two operational dimensions of the laser platform, i.e., the laser platform being operable to move the laser back and forth in the second direction and to rotate the laser on a second plane that is perpendicular to both the first plane and the first direction.

In some example embodiments, a working wavelength of the laser is within a preset wavelength range, and, a laser absorption rate in the preset wavelength range of the wear-resistant layer is lower than a laser absorption rate in the preset wavelength range of the decorative layer. As such, the decorative layer, that is designed to provide decorative appearance, has a relatively high absorption rate for the lase beam, while, the wear-resistant layer, that is typically formed of translucent materials, has a relatively low absorption rate for the laser beam. Therefore, by arranging the laser spot to cover a totality of a part of the decorative layer corresponding to the second corner, this allows the decorative layer to better absorb the energy, and consequentially have a faster increase in temperature. Therefore, the local linear heat treatment is achieved mainly based on the absorption of the laser beam by the decorative layer and the heat conduction from the decorative layer to the wear-resistant layer as well as the substrate layer. This helps to maintain the internal architecture of the board-shaped material unchanged, and prevent the wear-resistant layer and the substrate layer from cracking after receiving deforming pressure.

In some example embodiments, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot. As such, the rectangular laser spot with its long side parallel to the first direction along which the board-shaped material is moved, improves the heating performance in a sense that the rectangular shape of the laser spot better fits the geometry of the structural layers of the board-shaped material. Further, as the part of the decorative layer corresponding to the second corner is located at the geometric center of the rectangular laser spot, this helps the decorative layer to better absorb the energy by the laser and has a faster temperature increase, thereby improving the heating performance and overall efficiency. Further, as a length direction of the part of the decorative layer corresponding to the second corner is parallel to the long side of the rectangular laser spot, this helps to evenly distribute the energy within the heat region provided by the lase spot, thereby further improving the heating performance. Accordingly, the present disclosure provides a manufacturing device and method for floor panels that need different sizes of flooring and different sizes of rounded corners. Once precise positioning is carried out at one time, and then, a configurable laser spot illumination is used to soften the target corner while avoiding damage to the material and avoiding deformation cracking. Because the structural layers on the processing notch is retained, the overall process is simplified. Floor panels can be mass-produced and then have rounded corners at desired locations as required. In addition, the integration of a variety of tool configuration, such as a cutting-tool configuration, a laser-based board-shaped material processing device, and a pressing wheel tool configuration, makes it easy to move the entire processing system to any suitable position, facilitating rapid deployment and adaptation to different production environments.

In some embodiments, the wear-resistant layer adopts a translucent material, such as Polyvinyl chloride (PVC), i.e., the wear-resistant layer is formed by a polyvinyl chloride material. In some embodiments, the laser spot is a circular laser spot.

In some instances, the laser includes an emission source, a reflective mirror having a parabolic shape, and a convex lens, a laser beam emitted by the emission source first goes through a first focus by the reflective mirror and then goes through a second focus by the convex lens onto a working plane so as to obtain the rectangular laser spot, a length of the long side of the rectangular laser spot is determined base on a length of the emission source and a length of the reflective mirror, a length of a short side of the rectangular laser spot is determined base on a distance from the convex lens to the working plane. As such, the laser is configured for providing the rectangular laser spot that has benefits of improved heating performance and balanced energy distribution. It is noted that, the laser beam emitted by the laser that eventually forms the rectangular laser spot on the board-shaped material, goes through two focuses. The first focus is performed by the reflective mirror that reflects the laser beam emitted by the emission source. The second focus is performed by the convex lens that brings the laser beam reflected by the reflective mirror together at a focal point. The convex lens may be replaced with any type of optical arrangement that has similar effect of bringing incident light rays together at a point, such as a converging lens. Therefore, the first focus is based on light reflection, and the second focus is based on light transmission. As such, the second focus performed by the convex lens does not change the direction of the main optical axis of the laser beam, and the laser beam, before and after the second focus by the convex lens, has the same propagation direction, with light rays bent inward to meet at the focal point. This saves the resources and efforts for changing the main optical axis, and therefore helps to make the laser smaller and more efficient. Also, this internal design of the laser for producing the laser beam provides sufficient adaptiveness with respect to the dimensions of the rectangular laser spot. Specifically, a length of the long side of the rectangular laser spot is determined base on a length of the emission source and a length of the reflective mirror. This means that the laser may adopts an emission source that has a length from 500 millimeter (mm) to 1500 mm, and the length of the long side of the rectangular laser spot is ranged substantially from 500 mm to 1500 mm correspondingly. By adopting an appropriate value for the length of the emission source, the rectangular laser spot on the board-shaped material may just meet the requirements for local linear heat treatment, thereby improving energy efficiency. Also, a length of a short side of the rectangular laser spot is determined base on a distance from the convex lens to the working plane. The working plane refers to a plane where the laser beam forms the rectangular laser spot on the board-shaped material. As the convex lens serves to converge the laser beam reflected by the reflective mirror at the focal point, by adjusting the distance from the convex lens to the working plane, it is convenient to adjust the length of the short side of the rectangular laser spot and the size of the rectangular laser spot, as long as the working plane is located within the focal length. For example, if the focal length is 50 mm to 300 mm, the length of the short side of the rectangular laser spot may be set to 3 mm to 5 mm. It should be noted, the closer the distance from the convex lens to the working plane is to the focal length, the smaller the length of the short side of the rectangular laser spot becomes, and eventually at the focal point, which means the distance from the convex lens to the working plane is equal to the focal length, the rectangular laser spot shrinks into a line or a long light spot. Further, the energy distribution within the rectangular laser spot is largely determined by the emission source and the optical path design inside the laser. Here, the reflective mirror has a parabolic shape, and this helps to transform the laser beam from the emission source into relatively homogeneous parallel laser beam, which is beneficial to forming a rectangular laser spot with good energy uniformity. Accordingly, the internal design of the laser has advantages of adjusting the length and width of the rectangular laser spot, and adjusting the distribution pattern within the rectangular laser spot, in accordance with requirements of the local linear heat treatment.

In some instances, the emission source is deployed on a symmetrical centerline of the parabolic shape of the reflective mirror. The energy distribution within the rectangular laser spot is largely determined by the emission source and the optical path design inside the laser. Here, the optical path design includes two focuses before the laser beam is irradiated out from the laser. The first focus is performed by the reflective mirror that reflects the laser beam emitted by the emission source. The second focus is performed by the convex lens that brings the laser beam reflected by the reflective mirror together at a focal point. The reflective mirror has a parabolic shape and the emission source is deployed on a symmetrical centerline of the parabolic shape of the reflective mirror, therefore, it is beneficial to use the inner surface of the reflective mirror to provide collimation and focusing functions as much as possible. And, by deploying the emission source on the symmetrical center line of the parabolic shape of the reflective mirror, the emission light of the emission source can be better converted into a relatively uniform parallel beam, so that, after the focusing by the convex lens, the rectangular laser spot obtained has good uniformity.

FIG. 4 is a schematic view showing the local linear heat treatment of the processing notch of the board-shaped material by a first arrangement of the laser according to some embodiments. FIG. 4 depicts a board-shaped material 420 that has three structural layers, i.e., a substrate layer 431, a decorative layer 432, and a wear-resistant layer 433. along a second direction 493 perpendicular to the first plane are the substrate layer 431, the decorative layer 432, and the wear-resistant layer 433 of the board-shaped material 420 in turn. The board-shaped material 420 includes a processing notch 430. The processing notch 430 forms a first corner 434 and a second corner 436 with a surface of the board-shaped material 420. All of the first corner 434 is located in the substrate layer 431. The second corner 436 is simultaneously located in the substrate layer 431, the decorative layer 432, and the wear-resistant layer 433. The board-shaped material processing device is configured for, operating the laser platform such that a laser spot emitted by the laser 401 covers a portion of a part of the substrate layer 431 corresponding to the second corner 436 and a totality of a part of the decorative layer 432 corresponding to the second corner 436, and then, using the laser 401 to perform heat treatment so as to heat a part of the wear-resistant layer 433 corresponding to the second corner 436 to a moldable state, such that extrusion molding processing is applicable to the second corner 436 to form a rounded corner.

Referring to FIG. 4, the decorative layer 432 and the laser 401 are positioned at two opposite sides of the wear-resistant layer 433 in the second direction 493 respectively. Alternatively, a relative distance between the laser 401 and the decorative layer 432 in the second direction 493 is larger than a relative distance between the laser 401 and the wear-resistant layer 433 in the second direction 493. By defining that the laser 401 is movable back and forth in the second direction, and by defining that along the second direction 493 perpendicular to the first plane are the substrate layer 431, the decorative layer 432, and the wear-resistant layer 433 of the board-shaped material 420 in turn, therefore, the relative positional relationships in the second direction 493 between the laser 401 and the structural layers of the board-shaped material 420 may be established, and such relative positional relationships may fit into any way of placing the board-shaped material 420. In some examples, the second direction 493 is parallel to the gravity force direction, and the board-shaped material 420 is placed along a plane perpendicular to the direction of gravity. In some examples, the second direction 493 may deviate a little from the direction of gravity, like 10 degrees, and still, the above-mentioned laser-based board-shaped material processing device may still manufacture rounded corners in an efficient and cost-saving way. Here, the decorative layer 432 and the laser 401 are positioned at two opposite sides of the wear-resistant layer 433 in the second direction 493 respectively, this means that the laser beam emitted by the laser 401 comes from below the wear-resistant layer 433 in the second direction 493 to be irradiated on the wear-resistant layer 433. When the second direction 493 is parallel to the direction of gravity, the laser beam is designed to irradiate the wear-resistant layer 433 from the bottom up, which is the situation when the wear-resistant layer 433 is placed downward. This specific placement of the laser 401 and the decorative layer 432 along the second direction 493 helps to make sure that the decorative layer 432 receives most of the energy by the laser 401, especially when the wear-resistant layer 433 is formed of translucent materials with respect to the laser beam. Further, since the laser beam comes from below the wear-resistant layer 433 in the second direction 493, this specific placement helps to restrict the laser spot by the laser 401 to cover a portion of a part of the substrate layer 431 corresponding to the second corner 436, and therefore helps to prevent the laser spot from overlapping with the edge of the processing notch 430 defined by the first corner 434, thereby helping to prevent the high-energy laser from damaging the material.

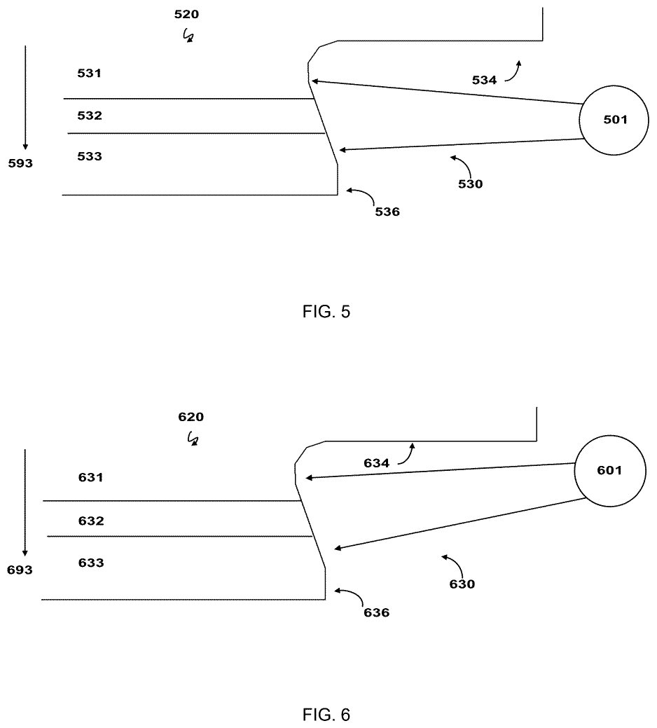

FIG. 5 is a schematic view showing the local linear heat treatment of the processing notch of the board-shaped material by a second arrangement of the laser according to some embodiments. FIG. 5 depicts a board-shaped material 520 that has three structural layers, i.e., a substrate layer 531, a decorative layer 532, and a wear-resistant layer 533. along a second direction 593 perpendicular to the first plane are the substrate layer 531, the decorative layer 532, and the wear-resistant layer 533 of the board-shaped material 520 in turn. The board-shaped material 520 includes a processing notch 530. The processing notch 530 forms a first corner 534 and a second corner 536 with a surface of the board-shaped material 520. All of the first corner 534 is located in the substrate layer 531. The second corner 536 is simultaneously located in the substrate layer 531, the decorative layer 532, and the wear-resistant layer 533. The board-shaped material processing device is configured for, operating the laser platform such that a laser spot emitted by the laser 501 covers a portion of a part of the substrate layer 531 corresponding to the second corner 536 and a totality of a part of the decorative layer 532 corresponding to the second corner 536, and then, using the laser 501 to perform heat treatment so as to heat a part of the wear-resistant layer 533 corresponding to the second corner 536 to a moldable state, such that extrusion molding processing is applicable to the second corner 536 to form a rounded corner.

Referring to FIG. 5, a relative distance between the laser 501 and the decorative layer 532 in the second distance 593 is essentially zero. The relative positional relationships in the second direction 593 between the laser 501 and the structural layers of the board-shaped material 520 may be established, and such relative positional relationships may fit into any way of placing the board-shaped material 520.

FIG. 6 is a schematic view showing the local linear heat treatment of the processing notch of the board-shaped material by a third arrangement of the laser according to some embodiments. FIG. 6 depicts a board-shaped material 620 that has three structural layers, i.e., a substrate layer 631, a decorative layer 632, and a wear-resistant layer 633. along a second direction 693 perpendicular to the first plane are the substrate layer 631, the decorative layer 632, and the wear-resistant layer 633 of the board-shaped material 620 in turn. The board-shaped material 620 includes a processing notch 630. The processing notch 630 forms a first corner 634 and a second corner 636 with a surface of the board-shaped material 620. All of the first corner 634 is located in the substrate layer 631. The second corner 636 is simultaneously located in the substrate layer 631, the decorative layer 632, and the wear-resistant layer 633. The board-shaped material processing device is configured for, operating the laser platform such that a laser spot emitted by the laser 601 covers a portion of a part of the substrate layer 631 corresponding to the second corner 636 and a totality of a part of the decorative layer 632 corresponding to the second corner 636, and then, using the laser 601 to perform heat treatment so as to heat a part of the wear-resistant layer 633 corresponding to the second corner 636 to a moldable state, such that extrusion molding processing is applicable to the second corner 636 to form a rounded corner.

Referring to FIG. 6, the decorative layer 632 and the laser 601 are both positioned at a same side of the wear-resistant layer 633 in the second direction 693. The relative positional relationships in the second direction 693 between the laser 601 and the structural layers of the board-shaped material 620 may be established, and such relative positional relationships may fit into any way of placing the board-shaped material 620.

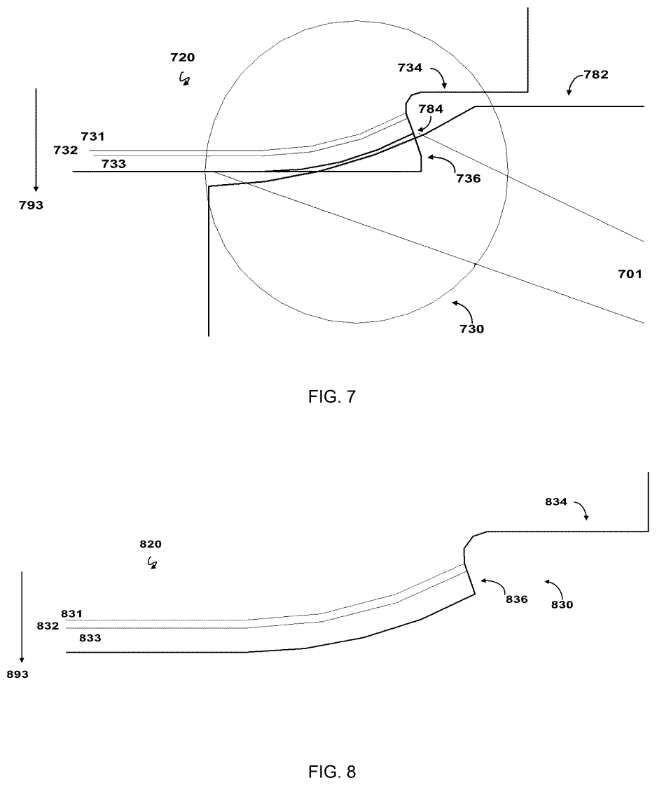

FIG. 7 is a schematic view showing the local linear heat treatment of the processing notch of the board-shaped material by the first arrangement of the laser, and, the extrusion molding processing applied to the processing notch, according to some embodiments. FIG. 7 depicts a board-shaped material 720 that has three structural layers, i.e., a substrate layer 731, a decorative layer 732, and a wear-resistant layer 733. along a second direction 793 perpendicular to the first plane are the substrate layer 731, the decorative layer 732, and the wear-resistant layer 733 of the board-shaped material 720 in turn. The board-shaped material 720 includes a processing notch 730. The processing notch 730 forms a first corner 734 and a second corner 736 with a surface of the board-shaped material 720. All of the first corner 734 is located in the substrate layer 731. The second corner 736 is simultaneously located in the substrate layer 731, the decorative layer 732, and the wear-resistant layer 733. The board-shaped material processing device is configured for, operating the laser platform such that a laser spot emitted by the laser 701 covers a portion of a part of the substrate layer 731 corresponding to the second corner 736 and a totality of a part of the decorative layer 732 corresponding to the second corner 736, and then, using the laser to perform heat treatment so as to heat a part of the wear-resistant layer 733 corresponding to the second corner 736 to a moldable state, such that extrusion molding processing is applicable to the second corner 736 to form a rounded corner.

Still referring to FIG. 7, two straight lines coming from the laser 701 indicates the propagation direction of the laser beam emitted by the laser 701, and with reference to the first arrangement of the laser as depicted in FIG. 4, the decorative layer 732 and the laser 701 are positioned at two opposite sides of the wear-resistant layer 733 in the second direction 793 respectively. As such, the laser beam emitted by the laser 701 comes from below the wear-resistant layer 733 in the second direction 793 to be irradiated on the wear-resistant layer 733. When the second direction 793 is parallel to the direction of gravity, the laser beam is designed to irradiate the wear-resistant layer 733 from the bottom up, which is the situation when the wear-resistant layer 733 is placed downward. This specific placement of the laser 701 and the decorative layer 732 along the second direction 793 helps to make sure that the decorative layer 732 receives most of the energy by the laser 701, especially when the wear-resistant layer 733 is formed of translucent materials with respect to the laser beam. The processing notch 730 is illustrated by a circle, that indicates the general heat region that is affected by the local linear heat treatment by the laser 701. The local linear heat treatment is achieved mainly based on the absorption of the laser beam by the decorative layer 732 and the heat conduction from the decorative layer 732 to the wear-resistant layer 733 as well as the substrate layer 731. FIG. 7 also shows a contour line 784 that shows the general contour of the processing notch 730 after the edge of the processing notch 730 defined by the second corner 736 is processed by a pressing wheel 782 of a pressing wheel tool configuration. Here, the pressing wheel tool configuration is used to perform extrusion molding processing to the second corner to form a rounded corner. This specific placement of the laser 701 and the decorative layer 732 along the second direction 793 helps to make sure that the decorative layer 732 receives most of the energy by the laser 701, especially when the wear-resistant layer 733 is formed of translucent materials with respect to the laser beam. Further, since the laser beam comes from below the wear-resistant layer 733 in the second direction 793, this specific placement helps to restrict the laser spot by the laser 701 to cover a portion of a part of the substrate layer 731 corresponding to the second corner 736, and therefore helps to prevent the laser spot from overlapping with the edge of the processing notch defined by the first corner 734, thereby helping to prevent the high-energy laser from damaging the material.

FIG. 8 is a schematic view showing the processing notch of the board-shaped material after the local linear heat treatment step and the extrusion molding processing step. FIG. 8 depicts a board-shaped material 820 that has three structural layers, i.e., a substrate layer 831, a decorative layer 832, and a wear-resistant layer 833. along a second direction 893 perpendicular to the first plane are the substrate layer 831, the decorative layer 832, and the wear-resistant layer 833 of the board-shaped material 820 in turn. The board-shaped material 820 includes a processing notch 830. The processing notch 830 forms a first corner 834 and a second corner 836 with a surface of the board-shaped material 820. All of the first corner 834 is located in the substrate layer 831. The second corner 836 is simultaneously located in the substrate layer 831, the decorative layer 832, and the wear-resistant layer 833.

Referring to FIG. 7 and FIG. 8, in FIG. 7, the second corner 736 of the processing notch 730 is heat and softened by the local linear heat treatment step and then processed by the extrusion molding processing step, while, in FIG. 8, the second corner 836 indicates the contour of the edge of the processing notch 830 after the local linear heat treatment step and the extrusion molding processing step. With reference to the contour line 784 that shows the general contour of the processing notch 730 after the edge of the processing notch 730 defined by the second corner 736 is processed by a pressing wheel 782 of a pressing wheel tool configuration, it can be seen that, the local linear heat treatment step and the extrusion molding processing step together, maintain the internal architecture of the processing notch 836 unchanged, and bend the structural layers of the board-shaped material 820 at the second corner 836 to have a rounded shape. The softened corner is extruded to form the rounded corner, while, the structural layers (such as wear-resistant layer 833, decorative layer 832, and substrate layer 831) at the corner of the board-shaped material 820 after extrusion and deformation are deformed as a whole to form the rounded corner. It is noted that, the whole procedure from performing the pre-cutting processing to performing heat treatment and then to performing extrusion molding processing, avoids overall heating treatment to the board-shaped material 820 and requires only local heat treatment to prepare the corner for extrusion molding processing, thereby preventing a deformation of the board-shaped material 820 that may be caused by overall heating treatment, greatly improving the stability of the high-quality corners.

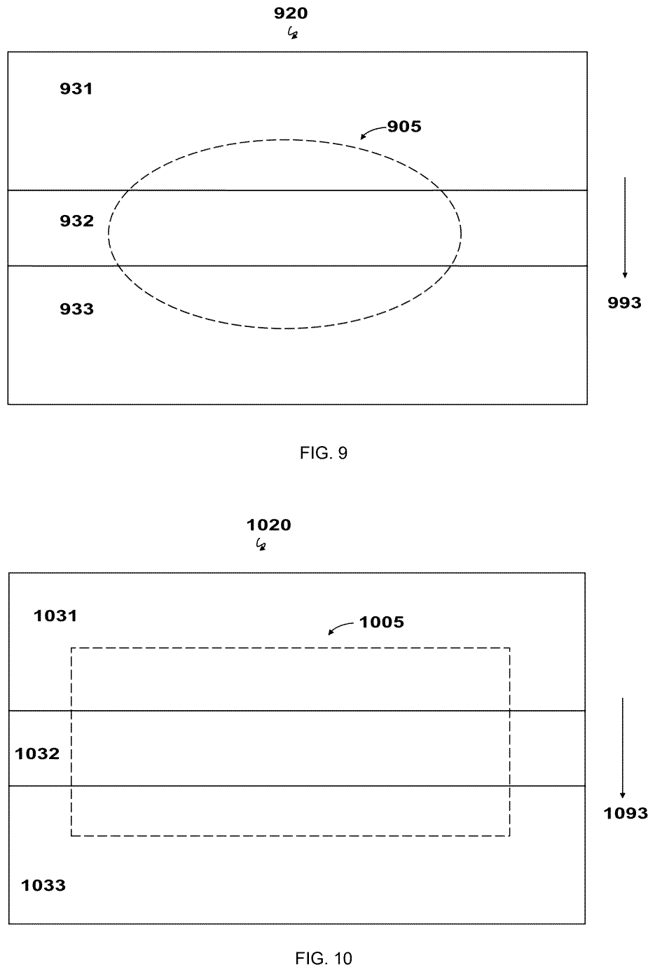

FIG. 9 is a schematic view showing a first type of the laser spot emitted by the laser. FIG. 9 depicts a board-shaped material 920 that has three structural layers, i.e., a substrate layer 931, a decorative layer 932, and a wear-resistant layer 933. along a second direction 993 perpendicular to the first plane are the substrate layer 931, the decorative layer 932, and the wear-resistant layer 933 of the board-shaped material 920 in turn. The laser spot 905 covers a portion of a part of the substrate layer 931 corresponding to the second corner and a totality of a part of the decorative layer 932 corresponding to the second corner. As such, by arranging the laser spot 905 to cover only a portion of a part of the substrate layer 931 corresponding to the second corner, and by defining that the laser spot 905 emitted by the laser covers is spaced away from a part of the substrate layer 931 corresponding to the first corner, this helps to control the laser spot 905 to cover a restricted region of the substrate layer 931, and therefore prevents the laser spot 905 from overlapping with the first corner. To this regard, by preventing the laser spot 905 from fully covering the part of the substrate layer 931 corresponding to the second corner, this restricts the laser spot 905 to stay within the edge of the processing notch defined by the second corner, and therefore helps to prevent the laser spot 905 from overlapping with the edge of the processing notch defined by the first corner, thereby helping to prevent the high-energy laser from damaging the material. Accordingly, most of the energy is absorbed by the decorative layer 932, and, when the temperature of the decorative layer 932 increases, the decorative layer 932 by heat conduction, causes the temperature of neighboring structural layers to increase, including causing the temperature of the wear-resistant layer 933 to increase. Also, the substrate layer 931 is heated in a limited way, with only a portion of a part of the substrate layer 931 corresponding to the second corner heated. Therefore, the local linear heat treatment is achieved mainly based on the absorption of the laser beam by the decorative layer 932 and the heat conduction from the decorative layer 932 to the wear-resistant layer 933 as well as the substrate layer 931. This helps to maintain the internal architecture of the board-shaped material 920 unchanged, and prevent the wear-resistant layer 933 and the substrate layer 931 from cracking after receiving deforming pressure.

FIG. 10 is a schematic view showing a second type of the laser spot emitted by the laser. FIG. 10 depicts a board-shaped material 1020 that has three structural layers, i.e., a substrate layer 1031, a decorative layer 1032, and a wear-resistant layer 1033. along a second direction 1093 perpendicular to the first plane are the substrate layer 1031, the decorative layer 1032, and the wear-resistant layer 1033 of the board-shaped material 1020 in turn. The laser spot 1005 covers a portion of a part of the substrate layer 1031 corresponding to the second corner and a totality of a part of the decorative layer 1032 corresponding to the second corner.

Referring to FIG. 10, the laser spot 1005 emitted by the laser is a rectangular laser spot 1005, a long side of the rectangular laser spot 1005 is parallel to the first direction, the part of the decorative layer 1032 corresponding to the second corner is located at a geometric center of the rectangular laser spot 1005, and, a length direction of the part of the decorative layer 1032 corresponding to the second corner is parallel to the long side of the rectangular laser spot 1005. As such, the rectangular laser spot 1005 with its long side parallel to the first direction along which the board-shaped material 1020 is moved, improves the heating performance in a sense that the rectangular shape of the laser spot 1005 better fits the geometry of the structural layers of the board-shaped material 1020. Further, as the part of the decorative layer 1032 corresponding to the second corner is located at the geometric center of the rectangular laser spot 1005, this helps the decorative layer 1032 to better absorb the energy by the laser and has a faster temperature increase, thereby improving the heating performance and overall efficiency. Further, as a length direction of the part of the decorative layer 1032 corresponding to the second corner is parallel to the long side of the rectangular laser spot 1005, this helps to evenly distribute the energy within the heat region provided by the lase spot 1005, thereby further improving the heating performance. Accordingly, the present disclosure provides a manufacturing device and method for floor panels that need different sizes of flooring and different sizes of rounded corners. Once precise positioning is carried out at one time, and then, a configurable laser spot illumination is used to soften the target corner while avoiding damage to the material and avoiding deformation cracking. Because the structural layers on the processing notch is retained, the overall process is simplified. Floor panels can be mass-produced and then have rounded corners at desired locations as required. In addition, the integration of a variety of tool configuration, such as a cutting-tool configuration, a laser-based board-shaped material processing device, and a pressing wheel tool configuration, makes it easy to move the entire processing system to any suitable position, facilitating rapid deployment and adaptation to different production environments.

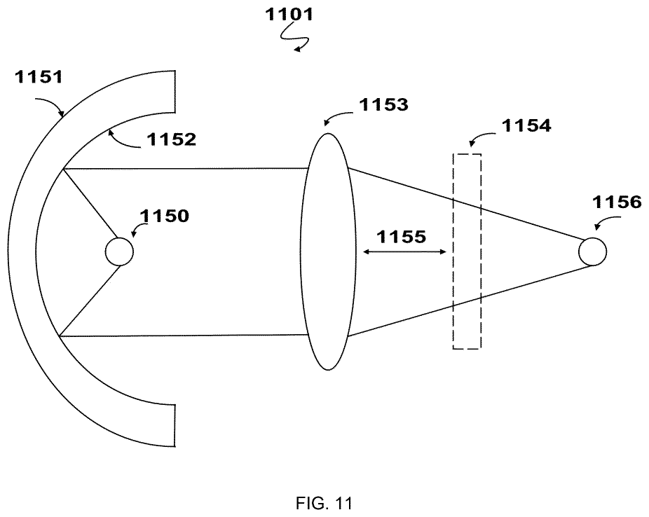

FIG. 11 is a block diagram illustrating the production of the second type of the laser spot. The laser 1101 includes an emission source 1150, a reflective mirror 1151 having a parabolic shape 1152, and a convex lens 1153, a laser beam emitted by the emission source 1150 first goes through a first focus by the reflective mirror 1151 and then goes through a second focus by the convex lens 1153 onto a working plane 1154 so as to obtain the rectangular laser spot. A length of the long side of the rectangular laser spot is determined base on a length of the emission source 1150 and a length of the reflective mirror 1151, a length of a short side of the rectangular laser spot is determined base on a distance 1155 from the convex lens 1153 to the working plane 1154. As such, the laser is configured for providing the rectangular laser spot that has benefits of improved heating performance and balanced energy distribution. It is noted that, the laser beam emitted by the laser that eventually forms the rectangular laser spot on the board-shaped material, goes through two focuses. The first focus is performed by the reflective mirror 1151 that reflects the laser beam emitted by the emission source 1150. The second focus is performed by the convex lens 1153 that brings the laser beam reflected by the reflective mirror 1151 together at a focal point 1156. The convex lens 1153 may be replaced with any type of optical arrangement that has similar effect of bringing incident light rays together at a point, such as a converging lens. Therefore, the first focus is based on light reflection, and the second focus is based on light transmission. As such, the second focus performed by the convex lens 1153 does not change the direction of the main optical axis of the laser beam, and the laser beam, before and after the second focus by the convex lens 1153, has the same propagation direction, with light rays bent inward to meet at the focal point 1156. This saves the resources and efforts for changing the main optical axis, and therefore helps to make the laser smaller and more efficient. Also, this internal design of the laser for producing the laser beam provides sufficient adaptiveness with respect to the dimensions of the rectangular laser spot. Specifically, a length of the long side of the rectangular laser spot is determined base on a length of the emission source 1150 and a length of the reflective mirror 1151. This means that the laser may adopts an emission source 1150 that has a length from 500 millimeter (mm) to 1500 mm, and the length of the long side of the rectangular laser spot is ranged substantially from 500 mm to 1500 mm correspondingly. By adopting an appropriate value for the length of the emission source 1150, the rectangular laser spot on the board-shaped material may just meet the requirements for local linear heat treatment, thereby improving energy efficiency. Also, a length of a short side of the rectangular laser spot is determined base on a distance from the convex lens 1153 to the working plane 1154. The working plane 1154 refers to a plane where the laser beam forms the rectangular laser spot on the board-shaped material. As the convex lens 1153 serves to converge the laser beam reflected by the reflective mirror 1151 at the focal point 1156, by adjusting the distance from the convex lens 1153 to the working plane 1154, it is convenient to adjust the length of the short side of the rectangular laser spot and the size of the rectangular laser spot, as long as the working plane 1154 is located within the focal length (defined by the focal point 1156). For example, if the focal length is 50 mm to 300 mm, the length of the short side of the rectangular laser spot may be set to 3 mm to 5 mm. It should be noted, the closer the distance from the convex lens 1153 to the working plane 1154 is to the focal length, the smaller the length of the short side of the rectangular laser spot becomes, and eventually at the focal point 1156, which means the distance from the convex lens 1153 to the working plane 1154 is equal to the focal length, the rectangular laser spot shrinks into a line or a long light spot. Further, the energy distribution within the rectangular laser spot is largely determined by the emission source 1150 and the optical path design inside the laser. Here, the reflective mirror 1151 has a parabolic shape 1152, and this helps to transform the laser beam from the emission source 1150 into relatively homogeneous parallel laser beam, which is beneficial to forming a rectangular laser spot with good energy uniformity. Accordingly, the internal design of the laser has advantages of adjusting the length and width of the rectangular laser spot, and adjusting the distribution pattern within the rectangular laser spot, in accordance with requirements of the local linear heat treatment.

Referring to FIG. 11, the emission source 1150 is deployed on a symmetrical centerline of the parabolic shape 1152 of the reflective mirror 1151. The energy distribution within the rectangular laser spot is largely determined by the emission source 1150 and the optical path design inside the laser. Here, the optical path design includes two focuses before the laser beam is irradiated out from the laser. The first focus is performed by the reflective mirror 1151 that reflects the laser beam emitted by the emission source 1150.

The second focus is performed by the convex lens 1153 that brings the laser beam reflected by the reflective mirror 1151 together at a focal point 1156. The reflective mirror 1151 has a parabolic shape 1152 and the emission source 1150 is deployed on a symmetrical centerline of the parabolic shape 1152 of the reflective mirror 1151, therefore, it is beneficial to use the inner surface of the reflective mirror 1151 to provide collimation and focusing functions as much as possible. And, by deploying the emission source 1150 on the symmetrical center line of the parabolic shape 1152 of the reflective mirror 1151, the emission light of the emission source 1150 can be better converted into a relatively uniform parallel beam, so that, after the focusing by the convex lens 1153, the rectangular laser spot obtained has good uniformity.

Referring to FIG. 1 to FIG. 11, a laser-based board-shaped material processing system is provided. The board-shaped material processing system includes a transporting unit and a laser heating unit. The transporting unit is configured for transporting a board-shaped material along a first direction on a first plane. The board-shaped material includes a substrate layer, a decorative layer, and a wear-resistant layer, and, along a second direction perpendicular to the first plane are the substrate layer, the decorative layer, and the wear-resistant layer of the board-shaped material in turn. The laser heating unit includes a laser and a laser platform. The laser is fixed on the laser platform. The laser platform is operable to move the laser back and forth in the second direction and to rotate the laser on a second plane that is perpendicular to both the first plane and the first direction. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. The laser heating unit is configured for, operating the laser platform such that a laser spot emitted by the laser covers a portion of a part of the substrate layer corresponding to the second corner and a totality of a part of the decorative layer corresponding to the second corner, and then, using the laser to perform heat treatment so as to heat a part of the wear-resistant layer corresponding to the second corner to a moldable state, such that extrusion molding processing is applicable to the second corner to form a rounded corner.

Accordingly, the laser-based board-shaped material processing system has advantages of reduced operation costs, increased lock qualities, and increased splicing stability, and is adaptive to fast changing consumer needs with respect to various sizes and angles of rounded corners in an efficient and cost-saving way.

In some embodiments, the decorative layer and the laser are positioned at two opposite sides of the wear-resistant layer in the second direction respectively. As such, with reference to the laser-based board-shaped material processing system, the decorative layer and the laser are positioned at two opposite sides of the wear-resistant layer in the second direction respectively, this means that the laser beam emitted by the laser comes from below the wear-resistant layer in the second direction to be irradiated on the wear-resistant layer. When the second direction is parallel to the direction of gravity, the laser beam is designed to irradiate the wear-resistant layer from the bottom up, which is the situation when the wear-resistant layer is placed downward. This specific placement of the laser and the decorative layer along the second direction helps to make sure that the decorative layer receives most of the energy by the laser, especially when the wear-resistant layer is formed of translucent materials with respect to the laser beam. Further, since the laser beam comes from below the wear-resistant layer in the second direction, this specific placement helps to restrict the laser spot by the laser to cover a portion of a part of the substrate layer corresponding to the second corner, and therefore helps to prevent the laser spot from overlapping with the edge of the processing notch defined by the first corner, thereby helping to prevent the high-energy laser from damaging the material.

In some embodiments, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer. As such, with reference to the laser-based board-shaped material processing system, the operation of the laser may be adjusted by changing the preset working power and the preset working time length so as to be adapted to a material characteristic of the wear-resistant layer and a size of the wear-resistant layer, thereby improving overall efficiency.

In some embodiments, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot. As such, with reference to the laser-based board-shaped material processing system, the rectangular laser spot with its long side parallel to the first direction along which the board-shaped material is moved, improves the heating performance in a sense that the rectangular shape of the laser spot better fits the geometry of the structural layers of the board-shaped material. Further, as the part of the decorative layer corresponding to the second corner is located at the geometric center of the rectangular laser spot, this helps the decorative layer to better absorb the energy by the laser and has a faster temperature increase, thereby improving the heating performance and overall efficiency. Further, as a length direction of the part of the decorative layer corresponding to the second corner is parallel to the long side of the rectangular laser spot, this helps to evenly distribute the energy within the heat region provided by the lase spot, thereby further improving the heating performance.

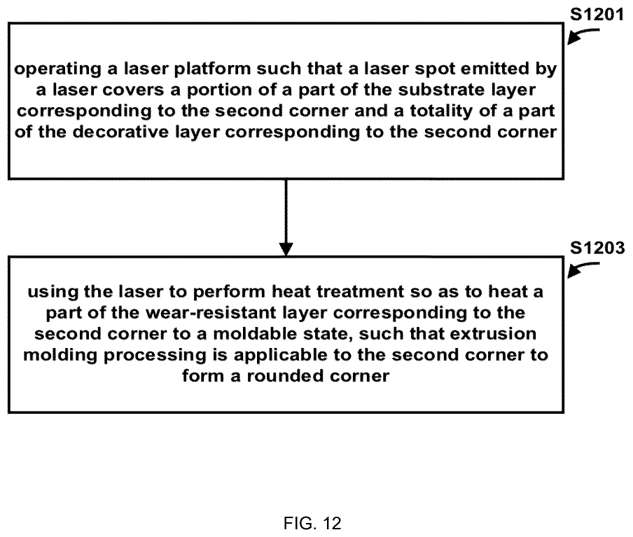

FIG. 12 is a flow char showing a laser-based board-shaped material processing method according to some embodiments. A board-shaped material that includes a substrate layer, a decorative layer, and a wear-resistant layer is movable along a first direction on a first plane. Along a second direction perpendicular to the first plane are the substrate layer, the decorative layer, and the wear-resistant layer of the board-shaped material in turn. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. The board-shaped material processing method includes the following steps.

Step S1201: operating a laser platform such that a laser spot emitted by a laser covers a portion of a part of the substrate layer corresponding to the second corner and a totality of a part of the decorative layer corresponding to the second corner.

Step S1203: using the laser to perform heat treatment so as to heat a part of the wear-resistant layer corresponding to the second corner to a moldable state, such that extrusion molding processing is applicable to the second corner to form a rounded corner.

Referring to FIG. 12, the laser is fixed on the laser platform. The laser platform is operable to move the laser back and forth in the second direction and to rotate the laser on a second plane that is perpendicular to both the first plane and the first direction.

Accordingly, the laser-based board-shaped material processing method has advantages of reduced operation costs, increased lock qualities, and increased splicing stability, and is adaptive to fast changing consumer needs with respect to various sizes and angles of rounded corners in an efficient and cost-saving way.

In some embodiments, the decorative layer and the laser are positioned at two opposite sides of the wear-resistant layer in the second direction respectively. As such, with reference to the laser-based board-shaped material processing method, the decorative layer and the laser are positioned at two opposite sides of the wear-resistant layer in the second direction respectively, this means that the laser beam emitted by the laser comes from below the wear-resistant layer in the second direction to be irradiated on the wear-resistant layer. When the second direction is parallel to the direction of gravity, the laser beam is designed to irradiate the wear-resistant layer from the bottom up, which is the situation when the wear-resistant layer is placed downward. This specific placement of the laser and the decorative layer along the second direction helps to make sure that the decorative layer receives most of the energy by the laser, especially when the wear-resistant layer is formed of translucent materials with respect to the laser beam. Further, since the laser beam comes from below the wear-resistant layer in the second direction, this specific placement helps to restrict the laser spot by the laser to cover a portion of a part of the substrate layer corresponding to the second corner, and therefore helps to prevent the laser spot from overlapping with the edge of the processing notch defined by the first corner, thereby helping to prevent the high-energy laser from damaging the material.

In some embodiments, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer. As such, with reference to the laser-based board-shaped material processing method, the operation of the laser may be adjusted by changing the preset working power and the preset working time length so as to be adapted to a material characteristic of the wear-resistant layer and a size of the wear-resistant layer, thereby improving overall efficiency.

In some embodiments, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot. the rectangular laser spot with its long side parallel to the first direction along which the board-shaped material is moved, improves the heating performance in a sense that the rectangular shape of the laser spot better fits the geometry of the structural layers of the board-shaped material. Further, as the part of the decorative layer corresponding to the second corner is located at the geometric center of the rectangular laser spot, this helps the decorative layer to better absorb the energy by the laser and has a faster temperature increase, thereby improving the heating performance and overall efficiency. Further, as a length direction of the part of the decorative layer corresponding to the second corner is parallel to the long side of the rectangular laser spot, this helps to evenly distribute the energy within the heat region provided by the lase spot, thereby further improving the heating performance.

In some embodiments, a working wavelength of the laser is within a preset wavelength range, and, a laser absorption rate in the preset wavelength range of the wear-resistant layer is lower than a laser absorption rate in the preset wavelength range of the decorative layer. As such, with reference to the laser-based board-shaped material processing method, by arranging the laser spot to cover a totality of a part of the decorative layer corresponding to the second corner, this allows the decorative layer to better absorb the energy, and consequentially have a faster increase in temperature. Therefore, the local linear heat treatment is achieved mainly based on the absorption of the laser beam by the decorative layer and the heat conduction from the decorative layer to the wear-resistant layer as well as the substrate layer. This helps to maintain the internal architecture of the board-shaped material unchanged, and prevent the wear-resistant layer and the substrate layer from cracking after receiving deforming pressure.

Referring to FIG. 1 through FIG. 12, the present disclosure provides a laser-based board-shaped material processing device, a laser-based board-shaped material processing system, and a laser-based board-shaped material processing method. The laser-based board-shaped material processing method as described above in various embodiments serves to perform the local linear heat treatment step, that may be used in a method for forming a board-shaped material with a mechanical locking. The board-shaped material with a mechanical locking may be used to form a floor panel or a wall panel or any suitable use. The mechanical locking has at least a coupling part that is a rounded corner formed by the laser-based board-shaped material processing method. Also, the board-shaped material with a mechanical locking may be formed by means of the laser-based board-shaped material processing device, or the laser-based board-shaped material processing system. Therefore, the detailed embodiments of the present disclosure can be used to support a scheme, which uses laser or infrared lights for heating then a pressing wheel for extrusion molding processing so as to form a rounded corner or a circular chamfering. The rounded corner may be used to form a mechanical lock for a board-shaped material with the mechanical lock.

In some embodiments, a board-shaped material with a mechanical floor is provided. The mechanical floor includes a rounded corner. The board-shaped material that includes a substrate layer, a decorative layer, and a wear-resistant layer is movable along a first direction on a first plane. Along a second direction perpendicular to the first plane are the substrate layer, the decorative layer, and the wear-resistant layer of the board-shaped material in turn. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. A laser-based board-shaped material processing method for forming the rounded corner includes: operating a laser platform such that a laser spot emitted by a laser covers a portion of a part of the substrate layer corresponding to the second corner and a totality of a part of the decorative layer corresponding to the second corner; and using the laser to perform heat treatment so as to heat a part of the wear-resistant layer corresponding to the second corner to a moldable state, such that extrusion molding processing is applicable to the second corner to form the rounded corner. The laser is fixed on the laser platform. The laser platform is operable to move the laser back and forth in the second direction and to rotate the laser on a second plane that is perpendicular to both the first plane and the first direction.

In some embodiments, the board-shaped material with the mechanical locking is used for a floor panel or a wall panel.

In some embodiments, the decorative layer and the laser are positioned at two opposite sides of the wear-resistant layer in the second direction respectively.

In some embodiments, a relative distance between the laser and the decorative layer in the second direction is larger than a relative distance between the laser and the wear-resistant layer in the second direction.

In some embodiments, a relative distance between the laser and the decorative layer in the second distance is essentially zero, or, the decorative layer and the laser are both positioned at a same side of the wear-resistant layer in the second direction.

In some embodiments, the board-shaped material processing device is further configured for, operating the laser platform such that the laser spot emitted by the laser covers is spaced away from a part of the substrate layer corresponding to the first corner.

In some embodiments, using the laser to perform heat treatment includes: using the laser to perform local linear heat treatment according to a preset working power and a preset working time length, the preset working power and the preset working time length are determined at least based on a material characteristic of the wear-resistant layer and a size of the wear-resistant layer.

In some embodiments, the board-shaped material processing device is further configured for, operating the laser platform so as to locate the part of the decorative layer corresponding to the second corner at a geometric center of the laser spot emitted by the laser.

In some embodiments, a working wavelength of the laser is within a preset wavelength range, and, a laser absorption rate in the preset wavelength range of the wear-resistant layer is lower than a laser absorption rate in the preset wavelength range of the decorative layer.

In some embodiments, the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot.

In some embodiments, the laser includes an emission source, a reflective mirror having a parabolic shape, and a convex lens, a laser beam emitted by the emission source first goes through a first focus by the reflective mirror and then goes through a second focus by the convex lens onto a working plane so as to obtain the rectangular laser spot, a length of the long side of the rectangular laser spot is determined base on a length of the emission source and a length of the reflective mirror, a length of a short side of the rectangular laser spot is determined base on a distance from the convex lens to the working plane.

In some embodiments, the emission source is deployed on a symmetrical centerline of the parabolic shape of the reflective mirror.

Referring to FIG. 1 through FIG. 12, the present disclosure provides a laser-based board-shaped material processing device, a laser-based board-shaped material processing system, and a laser-based board-shaped material processing method. A laser is used to perform heat treatment to a target corner, i.e., performing local linear heat treatment, so as to heat and soft the corner for subsequent extrusion molding processing, thereby obtaining a rounded corner for forming a mechanical lock of a board-shaped material. Here, the laser beam emitted by the laser may be in different wavelength bands, such as the infrared band and the ultraviolet band. Accordingly, an infrared laser can be deployed to provide a laser beam in the infrared band, so as to generate a light spot in the target area on the board-shaped material, such as a rectangular light spot. Also, an ultraviolet lasers can be deployed to provide a laser beam in the ultraviolet band. The specific wavelength band used can be adapted to the material properties of the board-shaped material, such as the absorption rate of a laser beam in a specific wavelength band.

It should be understood that, the various embodiments of the present disclosure generally uses a laser to emit laser beams for the local linear heat treatment, which means first using laser to heat and then using a pressing wheel for extrusion molding processing. In the embodiments of this present disclosure, the laser may be replaced with a light source, such as an infrared light source or an ultraviolet light source. Also, the light source may be understood to include not only a laser light source, but also a non-laser light source. As such, using the light emitted by the light source (laser or non-laser) to shine on a target region so as to achieve the purpose of local linear heat treatment, that is, first using the light source to heat and then using a pressing wheel for extrusion molding processing. Therefore, it helps to lower the costs. Below embodiments describe how to use a light source as the energy source for heat treatment.

The present disclosure provides a light-source-based board-shaped material processing device, a light-source-based board-shaped material processing system, and a light-source-based board-shaped material processing method. The light-source-based board-shaped material processing method as described above in various embodiments serves to perform the local linear heat treatment step, that may be used in a method for forming a board-shaped material with a mechanical locking. The board-shaped material with a mechanical locking may be used to form a floor panel or a wall panel or any suitable use. The mechanical locking has at least a coupling part that is a rounded corner formed by the light-source-based board-shaped material processing method. Also, the board-shaped material with a mechanical locking may be formed by means of the light-source-based board-shaped material processing device, or the light-source-based board-shaped material processing system. Therefore, the detailed embodiments of the present disclosure can be used to support a scheme, which uses a light source (such as laser or non-laser, or such as infrared light or ultraviolent light) for heating then a pressing wheel for extrusion molding processing so as to form a rounded corner or a circular chamfering. The rounded corner may be used to form a mechanical lock for a board-shaped material with the mechanical lock.

In some embodiments, a board-shaped material with a mechanical floor is provided. The mechanical floor includes a rounded corner. The board-shaped material that includes a substrate layer, a decorative layer, and a wear-resistant layer is movable along a first direction on a first plane. Along a second direction perpendicular to the first plane are the substrate layer, the decorative layer, and the wear-resistant layer of the board-shaped material in turn. The board-shaped material includes a processing notch. The processing notch forms a first corner and a second corner with a surface of the board-shaped material. All of the first corner is located in the substrate layer. The second corner is simultaneously located in the substrate layer, the decorative layer, and the wear-resistant layer. A light-source-based board-shaped material processing method for forming the rounded corner includes: operating a light source platform such that a light spot emitted by a light source covers a portion of a part of the substrate layer corresponding to the second corner and a totality of a part of the decorative layer corresponding to the second corner; and using the light source to perform heat treatment so as to heat a part of the wear-resistant layer corresponding to the second corner to a moldable state, such that extrusion molding processing is applicable to the second corner to form the rounded corner. The light source is fixed on the light source platform. The light source platform is operable to move the light source back and forth in the second direction and to rotate the light source on a second plane that is perpendicular to both the first plane and the first direction.

In some embodiments, the light source is an infrared light source or an ultraviolent light source.

In some embodiments, the light source is a laser light source or a non-laser light source.

In some embodiments, the board-shaped material with the mechanical locking is used for a floor panel or a wall panel.

In some embodiments, the decorative layer and the light source are positioned at two opposite sides of the wear-resistant layer in the second direction respectively.

In some embodiments, a relative distance between the light source and the decorative layer in the second direction is larger than a relative distance between the light source and the wear-resistant layer in the second direction.

In some embodiments, a relative distance between the light source and the decorative layer in the second distance is essentially zero, or, the decorative layer and the light source are both positioned at a same side of the wear-resistant layer in the second direction.

In some embodiments, the board-shaped material processing device is further configured for, operating the light source platform such that the light spot emitted by the light source covers is spaced away from a part of the substrate layer corresponding to the first corner.

In some embodiments, using the light source to perform heat treatment includes: using the light source to perform local linear heat treatment according to a preset working power and a preset working time length, the preset working power and the preset working time length are determined at least based on a material characteristic of the wear-resistant layer and a size of the wear-resistant layer.

In some embodiments, the board-shaped material processing device is further configured for, operating the light source platform so as to locate the part of the decorative layer corresponding to the second corner at a geometric center of the light spot emitted by the light source.

In some embodiments, a working wavelength of the light source is within a preset wavelength range, and, a light absorption rate in the preset wavelength range of the wear-resistant layer is lower than a light absorption rate in the preset wavelength range of the decorative layer.

In some embodiments, the light spot emitted by the light source is a rectangular light spot, a long side of the rectangular light spot is parallel to the first direction, the part of the decorative layer corresponding to the second corner is located at a geometric center of the rectangular light spot, and, a length direction of the part of the decorative layer corresponding to the second corner is parallel to the long side of the rectangular light spot.

In some embodiments, the light source includes an emission source, a reflective mirror having a parabolic shape, and a convex lens, a light beam emitted by the emission source first goes through a first focus by the reflective mirror and then goes through a second focus by the convex lens onto a working plane so as to obtain the rectangular light spot, a length of the long side of the rectangular light spot is determined base on a length of the emission source and a length of the reflective mirror, a length of a short side of the rectangular light spot is determined base on a distance from the convex lens to the working plane.

In some embodiments, the emission source is deployed on a symmetrical centerline of the parabolic shape of the reflective mirror.

To the extent that the term “includes” or “including” is employed in the detailed description or the claims, it is intended to be inclusive in a manner similar to the term “comprising” as that term is interpreted when employed as a transitional word in a claim. Furthermore, to the extent that the term “or” is employed in the detailed description or claims (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and so on, have been illustrated by describing examples, and while the examples have been described in considerable detail, it is not the intention of the applicants to restrict or in any way limit scope to such detail. It is, of course, not possible to describe every conceivable combination of components or methodologies for purposes of describing the systems, methods, and so on, described herein. Additional advantages and modifications will readily appear to those skilled in the art. Therefore, the invention is not limited to the specific details, the representative apparatus, and illustrative examples shown and described. Thus, this application is intended to embrace alterations, modifications, and variations that fall within the scope of the appended claims. Furthermore, the preceding description is not meant to limit the scope of the invention. Rather, the scope of the invention is to be determined by the appended claims and their equivalents.

The detailed embodiments provided in the present disclosure can be implemented by any one or a combination of hardware, software, firmware, or solid-state logic circuits, and can be implemented in combination with signal processing, control, and/or dedicated circuits. The equipment(s) or device(s) provided in the detailed embodiments of the present disclosure may include one or more processors (a microprocessor, a controller, a digital signal processor (DSP), an application specific integrated circuit (ASIC), a field programmable gate array(FPGA) and so on), and these processors process various computer-executable instructions to control the operations of the equipment(s) or device(s). The equipment(s) or device(s) provided in the detailed embodiments of the present disclosure may include a system bus or a data transmission system that couples various components together. The system bus may include any one of different bus structures or a combination of different bus structures, such as a memory bus or a memory controller, a peripheral bus, a universal serial bus, and/or a process or a local bus using any of a variety of bus architectures. The equipment(s) or device(s) provided in the detailed embodiments of the present disclosure may be provided separately, may also be a part of the system, or may be a part of other equipment or devices.

The detailed embodiments provided by the present disclosure may include a computer-readable storage medium or a combination with a computer-readable storage medium, such as one or more storage devices capable of providing non-transitory data storage. The computer-readable storage medium/storage device may be configured to store data, programmers and/or instructions, which when executed by the processor of the equipment(s) or device(s) provided in the present disclosure, would allow the equipment(s) or device(s) to implement related operations. The computer-readable storage medium/storage device may include one or more of the following characteristics: volatile, nonvolatile, dynamic, static, read/write, read-only, random access, sequential access, location addressability, file addressability and content addressability. In one or more exemplary embodiments, the computer-readable storage medium/storage device may be integrated into the equipment(s) or device(s) provided in the detailed embodiments of the present disclosure or belong to a public system. The computer-readable storage media/storage devices can include optical storage devices, semiconductor storage devices and/or magnetic storage devices, etc., and can also include random access memory (RAM), flash memory, read-only memory (ROM), erasable and programmable read-only memory (EPROM), electrically erasable programmable read-only memory (EEPROM), registers, hard disk, removable disk, recordable and/or rewritable compact disc (CD), digital versatile disc (DVD), large capacity storage medium device or any other form of suitable storage medium.

It will be appreciated that various of the above-disclosed embodiments and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1-15. (canceled)

16. A laser-based board-shaped material processing method, a board-shaped material that comprises a substrate layer, a decorative layer, and a wear-resistant layer being movable along a first direction on a first plane, along a second direction perpendicular to the first plane being the substrate layer, the decorative layer, and the wear-resistant layer of the board-shaped material in turn, the board-shaped material comprising a processing notch, the processing notch forming a first corner and a second corner with a surface of the board-shaped material, all of the first corner being located in the substrate layer, the second corner being simultaneously located in the substrate layer, the decorative layer, and the wear-resistant layer, wherein the board-shaped material processing method comprises:
operating a laser platform such that a laser spot emitted by a laser covers a portion of a part of the substrate layer corresponding to the second corner and a totality of a part of the decorative layer corresponding to the second corner; and
using the laser to perform heat treatment so as to heat a part of the wear-resistant layer corresponding to the second corner to a moldable state, such that extrusion molding processing is applicable to the second corner to form a rounded corner,
wherein, the laser is fixed on the laser platform, the laser platform is operable to move the laser back and forth in the second direction and to rotate the laser on a second plane that is perpendicular to both the first plane and the first direction,
wherein a working wavelength of the laser is within a preset wavelength range, and, a laser absorption rate in the preset wavelength range of the wear-resistant layer is lower than a laser absorption rate in the preset wavelength range of the decorative layer.

17. The board-shaped material processing method of claim 16, wherein the decorative layer and the laser are positioned at two opposite sides of the wear-resistant layer in the second direction respectively.

18. The board-shaped material processing method of claim 16, wherein using the laser to perform heat treatment comprises: using the laser to perform local linear heat treatment according to a preset working power and a preset working time length, wherein, the preset working power and the preset working time length are determined at least based on a material characteristic of the wear-resistant layer and a size of the wear-resistant layer.

19. The board-shaped material processing method of claim 16, wherein the laser spot emitted by the laser is a rectangular laser spot, a long side of the rectangular laser spot is parallel to the first direction, the part of the decorative layer corresponding to the second corner is located at a geometric center of the rectangular laser spot, and, a length direction of the part of the decorative layer corresponding to the second corner is parallel to the long side of the rectangular laser spot.

20. (canceled)

21. The board-shaped material processing method of claim 16, wherein a relative distance between the laser and the decorative layer in the second direction is larger than a relative distance between the laser and the wear-resistant layer in the second direction.

22. The board-shaped material processing method of claim 16, wherein a relative distance between the laser and the decorative layer in the second distance is essentially zero, or, the decorative layer and the laser are both positioned at a same side of the wear-resistant layer in the second direction.

23. The board-shaped material processing method of claim 16, further comprising: operating the laser platform such that the laser spot emitted by the laser covers is spaced away from a part of the substrate layer corresponding to the first corner.

24. The board-shaped material processing method of claim 16, further comprising: operating the laser platform so as to locate the part of the decorative layer corresponding to the second corner at a geometric center of the laser spot emitted by the laser.

25. The board-shaped material processing method of claim 19, wherein the laser comprises an emission source, a reflective mirror having a parabolic shape, and a convex lens, a laser beam emitted by the emission source first goes through a first focus by the reflective mirror and then goes through a second focus by the convex lens onto a working plane so as to obtain the rectangular laser spot, a length of the long side of the rectangular laser spot is determined based on a length of the emission source and a length of the reflective mirror, a length of a short side of the rectangular laser spot is determined based on a distance from the convex lens to the working plane.

26. The board-shaped material processing method of claim 25, wherein the emission source is deployed on a symmetrical centerline of the parabolic shape of the reflective mirror.
